(19) United States
(12) Patent Application Publication
(10) Pub. No.: US 2024/0306687 A1
(43) Pub. Date: Sep. 19, 2024

(54) SENSORY MODIFIERS

(71) Applicant: CARGILL, INCORPORATED, Wayzata, MN (US)

(72) Inventors: Carlos CARTER, Minneapolis, MN (US); Rama Krishna SARANGAPANI, St. Michael, MN (US); Wade Nolan SCHMELZER, St. Louis Park, MN (US)

(73) Assignee: CARGILL, INCORPORATED, Wayzata, MN (US)

(21) Appl. No.: 18/681,199

(22) PCT Filed: Aug. 5, 2022
(86) PCT No.: PCT/US2022/074565

§ 371 Date: Feb. 5, 2024

Related U.S. Application Data
(60) Provisional application No. 63/230,107, filed on Aug. 6, 2021.

(51) Int. Cl. A23L 27/00; A23L 27/40; A23L 33/16

(52) U.S. Cl. CPC A23L 27/84; A23L 27/40; A23L 27/86; A23L 33/16

(57) ABSTRACT

A potassium chloride composition including potassium chloride and a sensory modifier, such that the composition has reduced bitterness, reduced metallic notes, and/or an improved saltiness flavor profile relative to an equivalent composition without the sensory modifier. The sensory modifier may include a dicaffeoylquinic acid or salt thereof; and one or more compounds selected from the group consisting of monocaffeoylquinic acids, monoferuloylquinic acids, diferuloylquinic acids, monocoumaroylquinic acids, dicoumaroylquinic acids, and salts thereof.

### CROSS-REFERENCE TO RELATED APPLICATIONS

This application claims the benefit of U.S. Provisional Application No. 63/230,107, filed Aug. 6, 2022, which is incorporated by reference herein in its entirety.

### BACKGROUND

Similar to sugar, there continues to be concerted efforts around sodium reduction within the food and beverage industry, driven by changes in nutritional labeling and the medical industry. In addition to its preservative effect, sodium chloride (aka table salt) has a profound impact on the overall perception of characterizing flavors, including not only savory flavors, but also sweet flavors, such as chocolate. Although sodium chloride can be slightly reduced in certain “very salty” applications, in many applications these reductions would have detrimental efforts on product quality and consumer acceptability. Across the industry, potassium chloride has been coupled with sodium chloride in effort to reduce sodium intake. Depending on the application and sodium chloride use level, sodium reductions, up to 25%, have been possible, but deeper sodium reductions have been hindered by the differences in the saltiness profile and inherent aftertastes of potassium chloride.

### SUMMARY

The present disclosure provides compositions containing potassium chloride (KCl); and a sensory modifier comprising a dicaffeoylquicid acid or salt thereof; and at least one compound selected from the group consisting of monocaffeoylquinic acids, monoferuloylquinic acids, diferuloylquinic acids, monocoumaroylquinic acids, dicoumaroylquinic acids, and salts thereof. The ratio of KCl to sensory modifier may be between 12:1 and 45:1, between 15:1 and 40:1, or between 18:1 and 35:1. The composition may be a dry composition comprising at least 25% (wt) KCl, 30% (wt) KCl, 40% (wt) KCl, 40% (wt) to 99% (wt) KCl, 45% (wt) to 98% (wt) KCl, or 48% (wt) to 98% (wt) KCl. The composition may be a dry composition comprising 0.5% (wt) to 10% (wt) sensory modifier, 1% (wt) to 8% (wt) sensory modifier, 1% (wt) to 5% (wt) sensory modifier, or 2% (wt) to 8% (wt). When the composition is in water to form a solution, bitterness of the solution may be reduced by at least 0.5 units, at least 1 unit, at least 2 units, or at least 3 units relative to an aqueous solution prepared from an equivalent composition without the sensory modifier, wherein bitterness is measured by Standardized Bitterness Intensity Test. The sensory modifier may be present in the composition in an amount effective to reduce bitterness such that when the composition is dissolved in distilled water forming a solution with a KCl concentration of 3500 ppm, a bitterness score of the solution is reduced by at least 1 unit relative to a comparable solution without the sensory modifier, wherein bitterness score is determined by at least four panelists experienced in sensory testing using a roundtable methodology using a scale of 0 to 9 with a score of 0 indicating no bitterness and a score of 9 indicating extreme bitterness. When the composition is in an aqueous solution, saltiness linger, and/or saltiness onset of the composition may be increased relative to an equivalent aqueous solution without the sensory modifier.

The sensory modifier may comprise less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than 0.05% (wt) of chlorophyll; or less than 0.1% (wt) of furans, furan-containing chemicals, theobromine, theophylline, or trigonelline as a weight percentage on a dry weight basis of the sensory modifier. The sensory modifier may comprise 0% (wt) of malonate, malonic acid, oxalate, oxalic acid, lactate, lactic acid, succinate, succinic acid, malate, or malic acid; or 0% (wt) of chlorophyll. The dicaffeoylquinic acid or dicaffeoylquinic salt of the sensory modifier may comprise at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof. The total of all dicaffeoylquinic acids and dicaffeoylquinic salts present in the sensory modifier may comprise 10% (wt) or more, 15 wt % or more, 20% (wt) or more, 25% (wt) or more, 30% (wt) or more, 35% (wt) or more, 40% (wt) or more, 45% (wt) or more, 50% (wt) or more, 60% (wt) or more, 70% (wt) or more, 25-75% (wt), or 40-60% (wt) of a total weight of the sensory modifier. The sensory modifier may comprise a monocaffeoylquinic component selected from the group consisting of chlorogenic acid, neochlorogenic acid, cryptochlorogenic acid, and salts thereof. The sensory modifier may comprise a monocaffeoylquinic component and a dicaffeoylquinic component that together comprise more than 50% (wt), preferably more than 60% (wt), more than 70% (wt), more than 80% (wt), more than 90% (wt), or more than 95% (wt) of the sensory modifier.

The composition can additionally comprise sodium chloride (NaCl). The composition may be a dry composition comprising NaCl in an amount up to 75% (wt), 60% (wt), 50% (wt), 49% (wt), 48% (wt), or 45% (wt) of the composition. The composition may comprise KCl and NaCl in a ratio between 0.75:1 and 1:2.5.

The composition can additionally comprise an anticaking agent in an amount up to 1.0% (wt). The anticaking agent may be selected from the group consisting of magnesium carbonate, tricalcium phosphate, sodium ferrocyanide, and combinations thereof.

For example, the disclosure provides a beverage product, a dry powdered beverage, and/or a food product comprising the compositions described herein. The food product may be a seasoning, a sauce, a gravy, a dressing, a snack product, or a bakery product. The food product may comprise a potato chip, a popcorn, a cracker, a pretzel, or combinations thereof. The food product, beverage product, or dry powdered beverage may comprise 0.001 (wt)% to 1.0 (wt)%, 0.005 (wt)% to 0.5 (wt)%, or 0.075 (wt)% to 0.2 (wt)% of the sensory modifier. The food product, beverage product, or dry powdered beverage may comprise NaCl, KCl, or combinations thereof in an amount up to 1% (wt), up to 1.5% (wt), up to 2% (wt), or up to 5% (wt).

The disclosure also provides a food or beverage product comprising potassium chloride (KCl); and a sensory modifier comprising a dicaffeoylquicid acid or salt thereof; and at least one compound selected from the group consisting of monocaffeoylquinic acids, monoferuloylquinic acids, diferuloylquinic acids, monocoumaroylquinic acids, dicoumaroylquinic acids, and salts thereof. The ratio of KCl to sensory modifier may be between 12:1 and 45:1, between 15:1 and 40:1, or between 18:1 and 35:1. The product may comprise 0.01% (wt) to 5.0% (wt) KCl, 0.05% (wt) to 2.0% (wt), or 0.1% (wt) to 1.5% (wt) KCl. The product may comprise 0.01% (wt) to 5.0% (wt) KCl, 0.05% (wt) to 2.0% (wt), or 0.1% (wt) to 1.5% (wt) NaCl. The food product may comprise a seasoning, a sauce, a gravy, a dressing, a snack product, or a bakery product. Bitterness intensity of the food or beverage product is reduced by at least 0.5 units, at least 1 unit, at least 2 units, or at least 3 units relative to an equivalent food or beverage product lacking the sensory modifier, wherein bitterness intensity is measured by Standardized Bitterness Intensity Test.

The disclosure also provides a method for reducing bitterness in a potassium chloride (KCl) composition, the method comprising adding to a composition comprising KCl a sensory modifier comprising a dicaffeoylquicid acid or salt thereof and at least one compound selected from the group consisting of monocaffeoylquinic acids, monoferuloylquinic acids, diferulovlquinic acids, monocoumaroylquinic acids, dicoumaroylquinic acids, and salts thereof, wherein, when added in water to form a solution, bitterness of the solution is reduced relative to bitterness of an aqueous solution prepared from an equivalent KCl composition lacking the sensory modifier. The sensory modifier may be added to the KCl composition in an amount effective to reduce bitterness such that in a composition with a KCl concentration of 3500 ppm, a bitterness score of the composition is reduced by at least 1 unit relative to a comparable composition without the sensory modifier, wherein bitterness score is determined by at least four panelists experienced in sensory testing using a roundtable methodology using a scale of 0 to 9 with a score of 0 indicating no bitterness and a score of 9 indicating extreme bitterness. The composition may be a beverage product or a food product. The food product may comprise a seasoning, a sauce, a gravy, a dressing, a snack product, or a bakery product. The composition comprising KCl may additionally comprise sodium chloride (NaCl). For a composition comprising KCl and NaCl, the amount of sodium in the composition is at least 10%, at least 15%, at least 20%, at least 25%, at least 30%, at least 40%, or at least 50% less than the amount of sodium required in a composition having the same saltiness intensity value but lacking the sensory modifier, wherein the saltiness intensity value is measured by the Standardized Saltiness Intensity Test. The ratio of KCl to sensory modifier may be between 12:1 and 45:1, between 15:1 and 40:1, or between 18:1 and 35:1. The sensory modifier may be added in an amount such that the sensory modifier is 0.001% to 0.5%, 0.005% to 0.1%, 0.01% to 0.05% by weight of the composition.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

Unless expressly stated, ppm (parts per million), percentage, and ratios are on a by weight basis. Percentage on a by weight basis is also referred to as wt % or % (wt) below.

This disclosure relates to various potassium chloride and/or reduced sodium compositions which have improved sensory attributes, such as reduced bitterness, reduce metallic notes/metallic aftertaste, improved temporal aspects of saltiness, and the like. The disclosure further relates to compositions, such as food and beverage compositions, made with the potassium chloride and/or reduced sodium compositions, the food and beverage compositions having improved sensory attributes, such as reduce bitterness, reduced metallic notes/metallic aftertaste, improved temporal aspects of saltiness, and the like. The disclosure also relates, generally, to a sensory modifier and uses thereof. In various aspects, the sensory modifier contains one or more caffeoyl-substituted quinic acid, and salts thereof. The disclosure further relates to methods of reducing undesirable attributes associated with potassium chloride and providing an improved composition relative to potassium chloride compositions which lack the sensory modifier described herein.

### Compositions

The present disclosure provides compositions containing potassium chloride (KCl) with various improvements which serve to modify the sensory perception thereof in use. The potassium chloride compositions containing a sensory modifier can be in any suitable form, including but not limited to, a solid or a liquid.

The present disclosure also provides compositions containing both potassium chloride and sodium chloride (NaCl) with various improvements which serve to modify the sensory perception thereof in use. The potassium chloride and sodium chloride compositions containing a sensory modifier can be in any suitable form, including but not limited to, a solid or a liquid.

As used herein, the term “solid potassium chloride composition” refers to dry, solid composition comprising potassium chloride. The solid potassium chloride composition may be in the form of granules, a powder, a tablet, a cube, and the like. The solid potassium chloride composition may also include the sensory modifier, sodium chloride, or combinations thereof.

The solid potassium chloride compositions described herein can include at least 5%, at least 10%, at least 25%, at least 30%, at least 40%, at least 50%, at least 60%, at least 70%, or at least 80% KCl by weight of the composition. The solid potassium chloride composition can include between 5% to 99%, 10% to 98%, 25% to 95%, 30% to 90%, or 40% to 80% KCl by weight of the composition. The solid potassium chloride composition can include between 40% to 99% (wt) KCl, 45% (wt) to 98% (wt) KCl, or 48% (wt) to 98% (wt) KCl.

The amount of potassium chloride in the composition (e.g., a solid composition) may be determined based on the concentration of potassium chloride to be used in solution (e.g., a beverage) or in a food product. For example, the composition may include potassium chloride in an amount such that when the composition is added to water or aqueous solution, the resulting solution includes at least 0.05%, 0.1%, 0.15%, 0.2%, 0.3%, 0.4%, 0.5%, 0.6%, 0.7%, 0.8%, 0.9%, 1.0%, 1.5%, 2.0%, 2.5%, 5.0%, or at least 8.0% KCl by weight of the solution. The composition may include potassium chloride in an amount such that when the composition is added to water or aqueous solution, the resulting solution includes between 0.5% and 8.0%, between 0.1% and 5.0%, between 0.15% and 2.5%, or between 0.2% and 1.0% KCl by weight of the solution. The composition may include potassium chloride in an amount such that when the composition is used to prepare a food product, the food product contains at least 0.05%, 0.1%, 0.15%, 0.2%, 0.3%, 0.4%, 0.5%, 0.6%, 0.7%, 0.8%, 0.9%, 1.0%, 1.5%, 2.0%, 2.5%, 5.0%, or at least 8.0% KCl by weight of the food product. The composition may include potassium chloride in an amount such that when the composition is used to prepare a food product, the resulting solution includes between 0.5% and 8.0%, between 0.1% and 5.0%, between 0.15% and 2.5%, or between 0.2% and 1.0% KCl by weight of the food product.

The solid potassium chloride compositions described herein may additionally include sodium chloride (NaCl). The composition may include KCl and NaCl in a ratio between 0.75:1 and 1:2.5. The compositions described herein can include NaCl in an amount up to 75% (wt), 60% (wt), 50% (wt), 49% (wt), 48% (wt), or 45% (wt) of the composition. The composition may include 5% to 75%, 10% to 60%, or 20% to 50% NaCl based on the weight of the composition. The amount of NaCl in the composition may be determined based on the concentration of NaCl in solution or in a food product. For example, the composition may include NaCl in an amount such that, when added to water or an aqueous solution or when used to prepare a food product, the solution or food product includes at least 0.05%, 0.1%, 0.15%, 0.2%, 0.3%, 0.4%, 0.5%, 0.6%, 0.7%, 0.8%, 0.9%, 1.0%, 1.5%, 2.0%, 2.5%, 5.0%, or at least 8.0% NaCl by weight of the solution or food product.

The solid compositions described herein may include both KCl and NaCl together in an amount of at least 10%, at least 20%, at least 30%, at least 40%, at least 50%, at least 60%, at least 70%, at least 80%, at least 90%, or at least 95% of the composition. The solid compositions described may include both KCl and NaCl together such that when added to water or an aqueous solution or when used to prepare a food product, the solution or food product includes at least 0.05%, 0.1%, 0.15%, 0.2%, 0.3%, 0.4%, 0.5%, 0.6%, 0.7%, 0.8%, 0.9%, 1.0%, 1.5%, 2.0%, 2.5%, 5.0%, or at least 8.0% of the total of NaCl and KCl by weight of the solution or food product.

The composition may additionally include one or more anticaking agents. As used herein, “anticaking agent” refers to an additive used to prevent formation of lumps (i.e., caking) and for easing packaging, transport, flowability, and consumption of a given composition. For example, the composition may be a powdered or granular composition that includes an anticaking agent to prevent caking (e.g., by modifying the recrystallization structure of the composition) and/or to improve flow-ability (e.g., by surrounding particles or granules of the composition to draw away moisture. Suitable anticaking agents are known and described in the art including, but are not limited to, magnesium carbonate, tricalcium phosphate, sodium ferrocyanide, and combinations thereof. The anticaking agent may be included in a solid composition described herein in an amount up to 0.25%, up to 0.5%, up to 0.75%, or up to 1.0% by weight of the composition.

In some aspects, the composition described herein may contain a sweetener. Suitable sweeteners are known and described in the art. The sweetener can be at least one of a non-caloric sweetener or a caloric sweetener. The sweetener can be any type of sweetener, for example, a sweetener obtained from a plant or plant product, or a physically or chemically modified sweetener obtained from a plant, or a synthetic sweetener. Exemplary sweeteners include steviol glycosides, mogrosides, sucrose, fructose, glucose, erythritol, maltitol, lactitol, sorbitol, mannitol, xylitol, tagatose, trehalose, galactose, rhamnose, cyclodextrin (e.g., α-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, ribose, sucralose, acesulfame K, aspartame, saccharin, coupling sugars, soy bean oligosaccharides, and combinations thereof. D- or L-configurations can be used when applicable. Suitable sweeteners and aspects thereof are also described in PCT International Publication Nos. WO 2019/071220 and WO 2019/071182 and in US Patent Application Publication Nos. 2019/0223481 and 2019/0223483, each of which is incorporated by reference herein in its entirety.

In some aspects, the compositions described herein may contain additives including, but not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, flavorants and flavoring ingredients, astringent compounds, proteins or protein hydrolysates, surfactants, emulsifiers, weighing agents, gums, antioxidants, colorants, flavonoids, alcohols, polymers and combinations thereof. In some aspects, the additives may serve as a tablet binder to increase tablet strength and aid in forming the tablet. In some aspects, the additives may serve as a foam stabilizer. In some aspects, the additives may serve as an antifoaming agent. In some aspects, the additives may act to improve the temporal and flavor profile of the described compositions to provide a composition with a favorable taste when the composition is added to an aqueous solution. Examples of such ingredients and aspects thereof are described in PCT International Publication Nos. WO 2019/071220 and WO 2019/071182 and in US Patent Application Publication Nos. 2019/0223481 and 2019/0223483, each of which is incorporated by reference herein in its entirety.

The compositions described herein including KCl and a sensory modifier can also contain one or more functional ingredients, which provide a real or perceived heath benefit to the composition. Functional ingredients include, but are not limited to, saponins, antioxidants, dietary fiber sources, fatty acids, vitamins, glucosamine, minerals, preservatives, hydration agents, pain relievers, probiotics, prebiotics, weight management agents, osteoporosis management agents, phytoestrogens, long chain primary aliphatic saturated alcohols, phytosterols and combinations thereof. Examples of functional ingredients and aspects thereof are set forth in PCT International Publication Nos. WO 2019/071220 and WO 2019/071182 and in US Patent Application Publication Nos. 2019/0223481 and 2019/0223483, each of which is incorporated by reference herein in its entirety.

The compositions described herein can further comprise one or more bulking agents. Suitable “bulking agents” include, but are not limited to, maltodextrin (10 DE, 18 DE, or 5 DE), corn syrup solids (20 or 36 DE), sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propy lene glycol, polyols, poly dextrose, fructooligosaccharides, cellulose and cellulose derivatives, and the like, and mixtures thereof. Additionally, in accordance with still other aspects, granulated sugar (sucrose) or other caloric sweeteners such as crystalline fructose, other carbohydrates, or sugar alcohol can be used as a bulking agent due to their provision of good content uniformity without the addition of significant calories.

The compositions described herein can further comprise a binding agent. Suitable “binding agents” include, but are not limited to, magnesium stearate, dextrose, sorbitol, xyitol, lactose, polyvinylpyrolidone (PVP), mannitol, polyethylene glycol (PEG), polyols (e.g., sugar alcohols), and the like.

A composition described herein including KCl together with one or more sensory modifiers can be incorporated in or used to prepare any known edible material or other composition intended to be ingested and/or contacted with the mouth of a human or animal, such as, for example, pharmaceutical compositions, edible gel mixes and compositions, dental and oral hygiene compositions, foodstuffs (e.g., confections, condiments, chewing gum, cereal compositions, baked goods, baking goods, cooking adjuvants, dairy products, and tabletop sweetener compositions), and beverage products (e.g., beverages, beverage mixes, beverage concentrates, etc.). Examples of such compositions and aspects thereof are set forth in PCT International Publication Nos. WO 2019/071220 and WO 2019/071182 and in US Patent Application Publication Nos. 2019/0223481 and 2019/0223483, each of which is incorporated by reference herein in its entirety

A pharmaceutical composition comprises a pharmaceutically active substance and a pharmaceutically acceptable carrier or excipient material. A dental composition comprises an active dental substance, which improves the aesthetics or health of at least a portion of the oral cavity, and a base material, which is an inactive substance used as a vehicle.

The compositions described herein can be a beverage product or can be used to prepare a beverage product. As used herein a “beverage product” includes, but is not limited to, a ready-to-drink beverage, a beverage concentrate, a beverage syrup, frozen beverage, or a powdered beverage. Suitable ready-to-drink beverages include carbonated and non-carbonated beverages. Carbonated beverages include, but are not limited to, enhanced sparkling beverages, cola, lemon-lime flavored sparkling beverage, orange flavored sparkling beverage, grape flavored sparkling beverage, strawberry flavored sparkling beverage, pineapple flavored sparkling beverage, ginger-ale, soft drinks and root beer. Non-carbonated beverages include, but are not limited to fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, cafe au lait, milk tea, fruit milk beverages), beverages containing cereal extracts, smoothies and combinations thereof. Examples of frozen beverages include, but are not limited to, icees, frozen cocktails, daiquiris, pina coladas, margaritas, milk shakes, frozen coffees, frozen lemonades, granitas, and slushees. Beverage concentrates and beverage syrups can be prepared with an initial volume of liquid matrix (e.g., water) and the desired beverage ingredients. Full strength beverages are then prepared by adding further volumes of water. Powdered beverages are prepared by dry-mixing all of the beverage ingredients in the absence of a liquid matrix. Full strength beverages are then prepared by adding the full volume of water, liquid matrix, or aqueous solution.

In some aspects, a method of preparing a beverage provided herein includes adding a composition as described herein to a liquid matrix (e.g., water or an aqueous solution). The method can further comprise adding one or more sweeteners, additives and/or functional ingredients to the beverage or to the composition before adding it to the liquid matrix. In still another aspect, a method of preparing a beverage comprises combining a liquid matrix and a solid bitterant composition comprising a bitterant and a sensory modifier.

The compositions described herein can be a food product or can be used to prepare a food product. The food product may be any caloric or non-caloric food product suitable for human consumption. Suitable food products include, but are not limited to, confections, condiments, chewing gum, cereal compositions, baked goods, baking goods, cooking adjuvants, dairy products, tabletop sweetener compositions, seasoning, sauces, gravies, soups, dressings, snack products, and the like.

In some aspects, the compositions described herein may be applied topically (i.e., on the surface of) a food product. For example, the food product may be a snack product (e.g., potato chips, corn chips, popcorn, crackers, pretzels, and the like) and the compositions described herein including potassium chloride and one or more sensory modifiers may be topically applied to the snack product.

### Sensory Modifier

A sensory modifier is a compound or composition that in certain amounts changes the sensory characteristics or sensory attributes of a consumable, e.g., a beverage, a food product, etc. Non-limiting examples of sensory characteristics that a sensory modifier can change include bitterness, sourness, numbness, astringency, metallic notes, cloyingness, dryness, sweetness, starchiness, mouthfeel, temporal aspects of sweetness, temporal aspects of saltiness, temporal aspects of bitterness, or temporal aspects of any sensory characteristic described herein, as well as flavor notes, such as licorice, vanilla, prune, cotton candy, lactic, umami, pulse, and molasses flavor notes. The sensory modifier may enhance a sensory characteristic, such as enhancing flavor profile; may suppress a sensory characteristic, such as reducing bitterness and reducing metallic notes; or may change the temporal aspects of a sensory characteristic, e.g., by increasing the onset of saltiness, or a combination thereof. In some aspects, the amount of sensory modifier employed in a potassium chloride composition alters at least one sensory characteristic, e.g., the combination may have reduced bitterness, reduced metallic notes, and/or an improved saltiness temporal profile compared to the potassium chloride compositions without the sensory modifier.

The present disclosure provides a sensory modifier comprising one or more caffeoyl-substituted quinic acids, and salts thereof. In various aspects, the caffeoyl-substituted quinic acids comprise an ester derived from the carboxylic acid of caffeic acid and an alcohol of quinic acid. A “caffeoyl-substituted quinic acid” or “caffeoylquinic acid” as the terms are used herein, include monocaffeoylquinic acids and dicaffeoylquinic acids and salts thereof. Monocaffeoylquinic acids comprise an ester derived from a single caffeic acid and a quinic acid (e.g., chlorogenic acid (5-O-caffeoylquinic acid), neochlorogenic acid (3-O-caffeoylquinic acid), and cryptochlorogenic acid (4-O-caffeoylquinic acid)). Dicaffeoylquinic acids comprise an ester derived from two caffeic acids and a quinic acid (e.g., 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid)). Thus, the sensory modifier includes both acid forms and salt forms of caffeoyl-substituted quinic acids. Free acid forms of various caffeoyl-substituted quinic acids are shown in Table 1.

TABLE 1
Structures of various caffeoyl-substituted quinic acids.

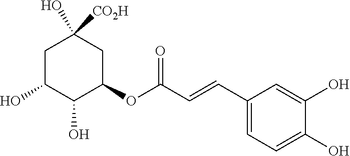 [SMILES: O=C(/C=C/c1ccc(O)c(O)c1)O[C@@H]1C[C@](O)(C(=O)O)C[C@@H](O)[C@H]1O]

Chlorogenic acid (5-O-caffeoylquinic acid)

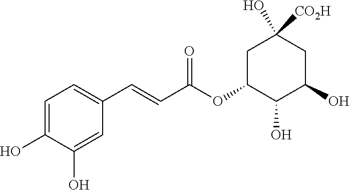 [SMILES: O=C(/C=C/c1ccc(O)c(O)c1)O[C@@H]1C[C@@](O)(C(=O)O)C[C@@H](O)[C@@H]1O]

Neochlorogenic acid (3-O-caffeoylquinic acid)

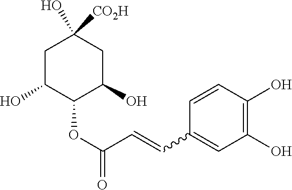 [SMILES: O=C(C=Cc1ccc(O)c(O)c1)O[C@H]1[C@H](O)C[C@](O)(C(=O)O)C[C@H]1O]

Cryptochlorogenic acid (4-O-caffeoylquinic acid)

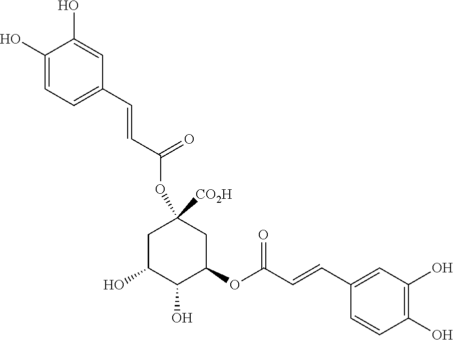 [SMILES: O=C(/C=C/c1ccc(O)c(O)c1)O[C@@H]1C[C@](OC(=O)/C=C/c2ccc(O)c(O)c2)(C(=O)O)C[C@@H](O)[C@H]1O]

1,5-Dicaffeoylquinic acid

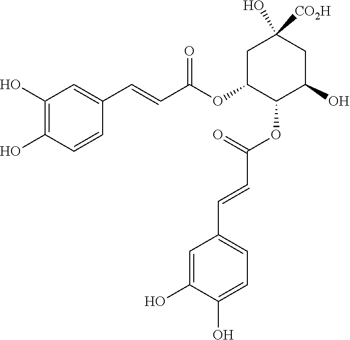 [SMILES: O=C(/C=C/c1ccc(O)c(O)c1)O[C@H]1[C@H](O)C[C@](O)(C(=O)O)C[C@H]1OC(=O)/C=C/c1ccc(O)c(O)c1]

3,4-Dicaffeoylquinic acid

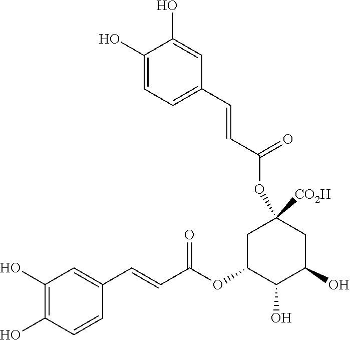 [SMILES: O=C(/C=C/c1ccc(O)c(O)c1)O[C@@H]1C[C@@](OC(=O)/C=C/c2ccc(O)c(O)c2)(C(=O)O)C[C@@H](O)[C@@H]1O]

1,3-Dicaffeoylquinic acid

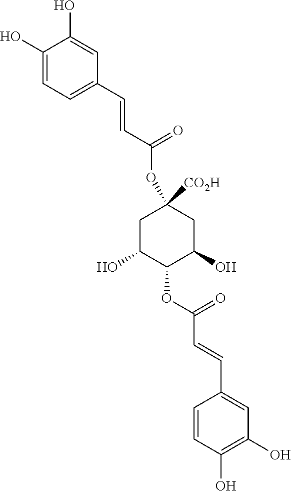 [SMILES: O=C(/C=C/c1ccc(O)c(O)c1)O[C@H]1[C@H](O)C[C@](OC(=O)/C=C/c2ccc(O)c(O)c2)(C(=O)O)C[C@H]1O]

1,4-Dicaffeoylquinic acid

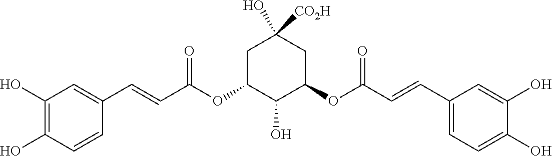 [SMILES: O=C(/C=C/c1ccc(O)c(O)c1)O[C@@H]1C[C@](O)(C(=O)O)C[C@@H](OC(=O)/C=C/c2ccc(O)c(O)c2)[C@H]1O]

3,5-Dicaffeoylquinic acid

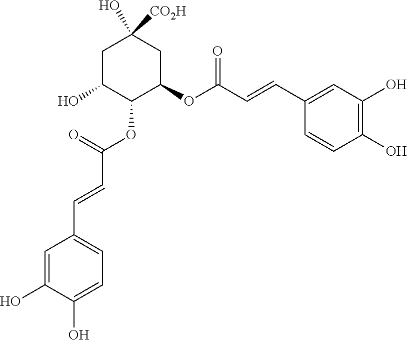 [SMILES: O=C(/C=C/c1ccc(O)c(O)c1)O[C@@H]1[C@H](O)C[C@@](O)(C(=O)O)C[C@H]1OC(=O)/C=C/c1ccc(O)c(O)c1]

4,5-Dicaffeoylquinic acid

In various aspects, the sensory modifier further comprises one or more of quinic acid, caffeic acid, ferulic acid, sinapic acid, p-coumaric acid, an ester of quinic acid, an ester of caffeic acid, an ester of ferulic acid, an ester of sinapic acid, an ester of p-coumaric acid, an ester of caffeic acid and quinic acid, an ester of caffeic acid and quinic acid comprising a single caffeic acid moiety, an ester of caffeic acid and quinic acid comprising more than one caffeic acid moiety, an ester of ferulic acid and quinic acid, an ester of ferulic acid and quinic acid comprising a single ferulic acid moiety, an ester of ferulic acid and quinic acid comprising more than one ferulic acid moiety, an ester of sinapic acid and quinic acid, an ester of sinapic acid and quinic acid comprising a single sinapic acid moiety, an ester of sinapic acid and quinic acid comprising more than one sinapic acid moiety, an ester of p-coumaric acid and quinic acid, an ester of p-coumaric acid and quinic acid comprising a single p-coumaric acid moiety, an ester of p-coumaric acid and quinic acid comprising more than one p-coumaric acid moiety, a di-ester of quinic acid containing one caffeic acid moiety and one ferulic acid moiety, a caffeic ester of 3-(3,4-dihydroxyphenyl)lactic acid, a caffeic acid ester of tartaric acid, a caffeic acid ester of tartaric acid containing more than one caffeic acid moieties, and/or isomers thereof, and the corresponding salts.

In some aspects, the sensory modifier comprises one or more of chlorogenic acid (5-O-caffeoylquinic acid), neochlorogenic acid (3-O-caffeoylquinic acid), cryptochlorogenic acid (4-O-caffeoylquinic acid), 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, 3-O-feruloylquinic acid, 4-O-feruloylquinic acid, 5-O-feruloylquinic acid, 1,3-diferuloylquinic acid, 1,4-diferuloylquinic acid, 1,5-diferuloylquinic acid, 3,4-diferuloylquinic acid, 3,5-diferuloylquinic acid, 4,5-diferuloylquinic acid, rosmarinic acid, caftaric acid (monocaffeoyltartaric acid), cichoric acid (dicaffeoyltartaric acid) and salts, and/or isomers thereof, and the corresponding salts.

In some aspects, the sensory modifier consists essentially of one or more compounds selected from the list consisting of chlorogenic acid (5-O-caffeoylquinic acid), neochlorogenic acid (3-O-caffeoylquinic acid), cryptochlorogenic acid (4-O-caffeoylquinic acid), 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid, and any combination thereof, isomers thereof, and the corresponding salts. In various aspects, one or more alcohol of the caffeoyl moiety is replaced with a hydrogen or substituted with an C₁-C₁₀ alkyl (e.g., methyl, ethyl, propyl, etc), C₁-C₁₀ alkenyl, C₆-C₁₀ aryl, C₂-C₁₀ acyl, acrylate, caffeoyl, o-coumaroyl, p-coumaroyl, m-coumaroyl, cinnamoyl, 4-hydroxy cinnamoyl, feruloyl, iso-feruloyl, sinapoyl, galloyl, sulfate, phosphate, or phosphonate. Thus, modified and substituted caffeic acid moieties result in a cinnamic acid, o-coumaroyl, p-coumaric acid, m-coumaric acid, ferulic acid, and the acyl and ester forms thereof. In various aspects, one or more alcohol of the quinic acid moiety is substituted with an C₁-C₁₀ alkyl (e.g., methyl, ethyl, propyl, etc), C₁-C₁₀ alkenyl, C₆-C₁₀ aryl, C₂-C₁₀ acyl, acrylate, caffeoyl, o-coumaroyl, p-coumaroyl, m-coumaroyl, cinnamoyl, 4-hydroxycinnamoyl, ferulovl, iso-feruloyl, sinapoyl, galloyl, sulfate, phosphate, or phosphonate.

The sensory modifier can include one or more of a caffeic ester of 3-(3,4-dihydroxyphenyl)lactic acid, a caffeic acid ester of tartaric acid, a ferulic ester of quinic acid or any other optionally-substituted cinnamoyl ester of quinic acid other than a caffeoylquinic acid. Examples of a ferulic ester of quinic acid includes 3-O-feruloylquinic acid, 4-O-feruloylquinic acid, 5-O-feruloylquinic acid, 1,3-diferuloylquinic acid, 1,4-diferuloylquinic acid, 1,5-diferuloylquinic acid, 3,4-diferuloylquinic acid, 3,5-diferuloylquinic acid, 4,5-diferuloylquinic acid, and combinations thereof. An example of a caffeic ester of 3-(3,4-dihydroxyphenyl)lactic acid is rosmarinic acid. Examples of a caffeic acid ester of tartaric acid includes cichoric acid (dicaffeoyltartaric acid) and caftaric acid (monocaffeoyltartaric acid) and combinations thereof.

In an alternative aspect, the sensory modifier is a mixture consisting of one or more of a caffeic ester of 3-(3,4-dihydroxyphenyl)lactic acid, a caffeic acid ester of tartaric acid, a ferulic ester of quinic acid or any other optionally-substituted cinnamoyl ester of quinic acid other than a caffeoylquinic acid. Such sensory modifier also includes salts thereof so as to have a salt fraction and an acid fraction. It is thus further envisaged that each of the various aspects described herein related to caffeoylquinic acid and other sensory modifiers can be equally applicable to this alternative.

Caffeic acid has the structure:

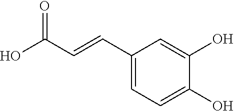 [SMILES: O=C(O)/C=C/c1ccc(O)c(O)c1]

Quinic acid has the structure:

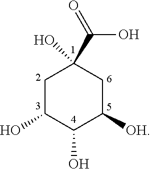 [SMILES: O=C(O)[C@]1(O)C[C@@H](O)[C@@H](O)[C@H](O)C1]

The structure provided above is D-(-)-quinic acid and the numbers shown correspond to current IUPAC numbering.

In various aspects, the sensory modifier can be enriched for one or more of caffeic acid, monocaffeoylquinic acids, and dicaffeoylquinic acids. The term “enriched” refers to an increase in an amount of one of caffeic acid, monocaffeoylquinic acids, and dicaffeoylquinic acids relative to one or more other compounds that are present in the sensory modifier. A sensory modifier that is enriched for one or more of caffeic acid, monocaffeoylquinic acids, and dicaffeoylquinic acids can modify the sensory attributes of the salt composition.

The sensory modifier enriched for one or more dicaffeoylquinic acids can modify the sensory attributes of a salt composition. A sensory modifier that is enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more dicaffeoylquinic acids as a percentage of the total weight of the sensory modifier.

In various aspects, at least or about 10 wt %, 15 wt %, 20 wt %, 25 wt %, 30 wt %, 35 wt %, 40 wt %, 45 wt %, or at least or about 50 wt % of the total sensory modifier can be monocaffeoylquinic acids and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be chlorogenic acid (5-O-caffeoylquinic acid) and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be neochlorogenic acid (3-O-caffeoylquinic acid) and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be cryptochlorogenic acid (4-O-caffeoylquinic acid) and salts thereof.

In various further aspects, at least or about 10 wt %, 15 wt %, 20 wt %, 25 wt %, 30 wt %, 35 wt %, 40 wt %, 45 wt %, or at least or about 50 wt % of the total sensory modifier can be 1,3-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 1,4-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 1,5-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 3,4-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 3,5-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 4,5-dicaffeoylquinic acid and salts thereof.

The sensory modifier can, for example, have a weight ratio of total monocaffeoylquinic acids and salts to total dicaffeoylquinic acids and salts of 20:1 to 1:20, e.g., from 3:1 to 1:20. In various aspects, the sensory modifier has a weight ratio from 15:1 to 1:15, from 10:1 to 1:10, from 5:1 to 1:5, from 3:1 to 1:3, from 2:1 to 1:2, from 1.5:1 to 1:1.5, from 5:1 to 1:1, from 3:1 to 1:1, from 2:1 to 1:1, from 1.5:1 to 1:1.1, from 1:1 to 1:20, from 1:1 to 1:15, from 1:1 to 1:10, from 1:5 to 1:20, from 1:5 to 1:15, from 1:5 to 1:10, from 1:2 to 1:20, from 1:2 to 1:15, from 1:2 to 1:10, from 1:2 to 1:5, from 1:1 to 1:3, from 1:1 to 1:2, or from 1:1 to 1:1.5 monocaffeoylquinic acid and salts thereof:dicaffeoylquinic acids and salts thereof. In some aspects, the sensory modifier has a greater amount, by weight, of dicaffeoylquinic acids and salts of dicaffeoylquinic acids compared to the amount of monocaffeoylquinic acids and salts of monocaffeoylquinic acids. In various aspects, the sensory modifier has a ratio of about 1:1 of monocaffeoylquinic acid:dicaffeoylquinic acids, including salts thereof.

The sensory modifier provided herein may contain a portion that is in salt form (corresponding to a “salt fraction”) and a portion that is in acid form (corresponding to an “acid fraction”). In various aspects, the salt fraction accounts for at least 50 wt % of the total sensory modifier. In various aspects, the sensory modifier comprises a salt fraction and an acid fraction, wherein the salt fraction comprises one or more of a salt of a monocaffeoylquinic acid and a salt of a dicaffeoylquinic acid, wherein the acid fraction comprises one or more of a monocaffeoylquinic acid and a dicaffeoylquinic acid, and wherein the salt fraction comprises at least 50 wt % of the total sensory modifier.

For example, the salt fraction comprises at least or about 50 wt %, 55 wt %, 60 wt %, 65 wt %, 70 wt %, 75 wt %, 80 wt %, 85 wt %, or at least or about 90 wt % of the total sensory modifier. In further aspects, the salt fraction comprises less than or about 60 wt %, 65 wt %, 70 wt %, 75 wt %, 80 wt %, 85 wt %, or less than or about 90 wt % of the total sensory modifier. In yet further aspects, the salt fraction comprises 50 wt % to 90 wt %, 50 wt % to 80 wt %, 50 wt % to 75 wt %, 60 wt % to 90 wt %, 60 wt % to 80 wt %, 65 wt % to 80 wt %, or 65 wt % to 75 wt % of the total sensory modifier. Unless otherwise specified the wt % of the salt fraction should be calculated inclusive of the balancing cation species.

In further examples, the acid fraction comprises at least or about 5 wt %, 10 wt %, 15 wt %, 20 wt %, 25 wt %, 30 wt %, 35 wt %, 40 wt %, or at least or about 45 wt % of the total sensory modifier. In further aspects, the acid fraction comprises less than or about 10 wt %, 15 wt %, 20 wt %, 25 wt %, 30 wt %, 35 wt %, 40 wt %, or less than about 50 wt % of the total sensory modifier. In yet further aspects, the acid fraction comprises 5 wt % to 50 wt %, 10 wt % to 50 wt %, 15 wt % to 50 wt %, 20 wt % to 50 wt %, 5 wt % to 40 wt %, 10 wt % to 40 wt %, 15 wt % to 40 wt %, 20 wt % to 40 wt %, 5 wt % to 35 wt %, 10 wt % to 35 wt %, 15 wt % to 35 wt %, 20 wt % to 35 wt %, 5 wt % to 30 wt %, 10 wt % to 30 wt %, 15 wt % to 30 wt %, 20 wt % to 30 wt %, 5 wt % to 20 wt %, 10 wt % to 20 wt %, 15 wt % to 20 wt %, 5 wt % to 15 wt %, 10 wt % to 15 wt %, or 5 wt % to 10 wt % of the total sensory modifier.

In various aspects, e.g., in an aqueous solution, the salt form of the total sensory modifier exists in equilibrium with the acid form. For example, a particular salt form molecule can become protonated and thus convert into the acid form and an acid form molecule can be come deprotonated to result in a salt form. After approaching or achieving equilibrium, such interplay will not substantially alter the overall wt % of a given form or fraction of the total sensory modifier. For example, a composition having a salt fraction of 50 wt % or more of the total sensory modifier can maintain the same proportions of salt and acid fractions even though the various compounds might exchange from one fraction to another.

There are also cases where the equilibrium between salt and acids forms can shift in response to the addition of components to the composition. For example, addition of buffer solution, salts, acid, or base can shift the equilibrium to favor the salt or acid fraction, and thus alter the wt % of the composition.

In various other aspects, e.g., in a solid composition, the salt form and acid forms can be in a solid state, in which the proportion between salt and acid forms is frozen. It should be understood that, in various aspects, the ratio of the salt fraction to acid fraction in a solid composition, such as a granulated salt composition, can differ from that of a resulting solution to which the solid composition is added. For example, in some aspects, a solid state salt composition will, upon dissolving or disintegrating, result in a solution having a sensory modifier of which at least 50 wt % is in salt form.

### Effective Amount of Sensory Modifier

The compositions of the present disclosure comprise a sensory modifier in an amount effective to reduce bitterness and/or reduce off-tastes of the potassium chloride composition when added to water or an aqueous solution or when present in a food product or beverage.

As used herein, “off-taste(s)” refer to a taste or flavor profile that is not characteristic or usually associated with a substance or composition as described herein and/or a characteristic taste or flavor associated with a substance or composition that is undesirable. For example, the off-taste may be an undesirable taste such as bitterness, undesirable mouthfeel such as astringency, mouth drying, undesirable flavor such as rancid, cardboard, aftertaste, inconsistent flavor (e.g., a flavor with an uneven onset or intensity, a flavor that may be perceived too early or too late), and the like.

A sensory panel can be used to determine the magnitude of reduction in bitterness or shifts in its temporal profile, thereby quantifying the amount of sensory modifier effective to reduce bitterness. Sensory panels are a scientific and reproducible method that is essential to the food and beverage industry. A sensory panel involves a group of two or more individual panelists. Panelists are instructed according to industry-recognized practices to avoid the influence of personal subjectivity and strengthen reproducibility. For example, panelists may objectively evaluate sensory attributes of a tested product but may not provide subjective attributes such as personal preference. In various aspects, the sensory panel can be conducted with two, three, four, five, six, or more panelists, in which the panelists identify and agree on a lexicon of sensory attributes for a given set of samples. After evaluating a specific sample, the panelists can assign a numerical intensity score for each attribute using an intensity scale. For example, intensity scales can range from 0 to 6 (i.e., 0=not detected, 1=trace, 2=slight, 3=moderate, 4=definite, 5=strong, 6=extreme), 0 to 9 (i.e., 0=not detected, 1=trace, 2=faint, 3=slight, 4=mild, 5=moderate, 6=definite, 7=strong, 8=very strong, 9=extreme), or 0 to 15, where 0 corresponds to the absence of the attribute, while 6, 9, or 15, respectively, corresponds to the upper bound extreme occurrence of the attribute. The panel may use a roundtable consensus approach or the panelists may score and evaluate the sensory attribute(s) individually. Either format can further involve a panel leader who directs the discussion regarding terminology and directs the panel to evaluate particular products and attributes. In other aspects, a trained sensory panel can be utilized to assess specific attributes using descriptive analysis or time intensity methodologies.

As used herein, “panelist” refers to a highly trained expert taster, such as those commonly used for sensory methodologies such as descriptive analysis, and/or an experienced taster familiar with the sensory attribute(s) being tested. In some aspects, the panelist may be a trained panelist. A trained panelist has undergone training to understand the terms and sensory phenomenon associated with those sensory attributes relevant to the tested product and are aligned on the use of common descriptors for those sensory attributes of interest (i.e., a sensory lexicon). For example, a trained panelist testing a given composition will understand the terms and sensory attributes associated with said composition, e.g., saltiness, sourness, bitterness, astringency, mouthfeel, acidity, and the like. The trained panelist will have been trained against reference samples corresponding to the sensory attributes being tested and thus have calibrated to recognize and quantitatively assess such criteria. In some aspects, the panelist may be an experienced taster.

As used herein, “roundtable consensus approach” refers to the sensory panel assay methodology wherein panelists discus sensory attributes and intensities before mutually agreeing on an intensity score and attribute characterization for the particular sensory attribute(s) being assayed. A sensory panel using a roundtable consensus approach may include 2, 3, 4, 5, 6, or more panelists. Consensus intensity scales can range from 0 to 6 (i.e., 0=not detected, 1=trace, 2=slight, 3=moderate, 4=definite, 5=strong, 6=extreme) or 0 to 9 (i.e., 0=not detected, 1=trace, 2=faint, 3=slight, 4=mild, 5=moderate, 6=definite, 7=strong, 8=very strong, 9=extreme). For a given set of samples, the panelists will identify and agree on a lexicon of sensory attribute, including, if applicable, reference or standardized samples (also referred to as sensory anchors) for a particular sensory attribute. The reference sample(s) used for a given sensory attribute(s) will depend on the samples being assayed and the lexicon of sensory attributes determined by the panel. One of skill in the art will recognize the appropriate lexicon and reference or standard samples necessary for sensory assessment of a given sample(s).

In some aspects, the samples are scored and evaluated by panelists independently after panelists have agreed upon or been instructed in a lexicon of sensory attributes and intensity scores including, if applicable, assay specific calibration on reference samples (also referred to as sensory anchors) for a particular sensory attribute. Examples of common reference samples are described below. Panelists may evaluate samples in replicate and may be blinded to the samples they are testing. Samples being tested may be provided to the panelists randomly or in a sequential order. In some aspects, samples may be tested by panelists using a randomized balanced sequential order. Scores from individual panelists are then assessed using standard statistical analysis methods to determine an average sensory intensity score. One of skill in the art will recognize the appropriate lexicon and reference or standard samples necessary for sensory assessment of a given sample(s) as well as the appropriate statistical analysis methods.

As used herein, “randomized balanced sequential order” refers to the order in which samples are presented in which the order is randomized but across all panelists all possible orders of the samples will be presented to remove bias for the samples being tested in a particular order. For example, for a randomized balanced sequential order of two samples, there would be an equal likelihood that a given panelist receives sample 1 before sample 2 and sample 2 before sample 1. In an example with three samples (i.e., samples 1, 2, and 3), a randomized balanced sequential order would include an equal likelihood that panelists receiving samples in the following orders: (i) 1, 2, 3; (ii) 1, 3, 2; (iii) 2, 1, 3; (iv) 2, 3, 1; (v) 3, 2, 1; (vi) 3, 1, 2.

A sensory attribute(s) of a given composition may be evaluated in comparison to one or more reference or anchor samples. For example, sodium chloride solutions can be used by experienced panelists as saltiness anchors to assess the relative intensity of saltiness for a given composition; sucrose solutions can be used by experienced panelists as sweetness anchors to assess the relative intensity of sweetness for a given composition; citric acid solutions can be used by experienced panelists as sourness anchors to assess the relative intensity of sourness for a given composition; caffine solutions can be used by experienced panelists as bitterness anchors to assess the relative intensity of bitterness for a given composition; and monosodium glutamate (MSG) solutions can be used by experienced panelists as umami anchors to assess the relative intensity of umami for a given composition. Experienced panelists can be presented with a solution to assess sensory attributes, e.g., 10-20 mL of a sample. Panelists will dispense approximately 3-4 mL of each solution into their own mouths, disperse the solution by moving their tongues, and record a value for the particular sensory attribute being tested. If multiple solutions are to be tested in a session, the panelists may cleanse their palates with water between samples. For example, a roundtable assessment of saltiness, sweetness, sourness, umami, and the like can assign a scale of 0 to 9 with, e.g., a score of 0 indicating no saltiness and a score of 9 indicating extreme saltiness (0=not detected, 1=trace, 2=faint, 3=slight, 4=mild, 5=moderate, 6=definite, 7=strong, 8=very strong. 9=extreme). Equivalent scales and methodologies can be used for sweet, bitter, sour, and umami sensory attributes.

As a further example, saltiness of a composition can be tested by a panel of at least two panelists. The panelists can use a standard range of 0.18% (wt), 0.2% (wt), 0.35% (wt), 0.5% (wt), 0.567% (wt), 0.6% (wt), 0.65% (wt), and 0.7% (wt) sodium chloride solutions in water corresponding to a saltiness intensity value of 2, 2.5, 5, 8.5, 10, 11, 13, and 15, respectively. A skilled artisan will recognize that depending on the sample/composition being tested, the number and range of standard solutions may be changed (e.g., using only the solutions corresponding to the 2, 2.5, and 5 saltiness intensity values). For each test composition, the panelists dispenses approximately 2-5 mL, for liquid compositions or solutions prepared with water, or 5-10 g, for solid compositions, of each composition into their own mouths, disperses the composition by moving their tongues/chewing, and records a saltiness intensity value between 0 and 15 for each composition based on comparison to the aforementioned standard sodium chloride solutions. Between tasting compositions, the panelists are able to cleanse their palates with water. The panelists also can taste the standard 0.18%, 0.2%, 0.35%, 0.5%, 0.567%, 0.6%, 0.65%, and 0.7% sodium chloride solutions ad libitum between tasting test solutions to ensure recorded saltiness intensity values are accurate against the scale of the standard sodium chloride solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Saltiness Intensity Test.”

Sourness of a composition can be tested by a panel of at least two panelists. The panelists can use a standard range of 0.035% (wt), 0.05% (wt), 0.07% (wt), 0.15% (wt), and 0.2% (wt) citric acid solutions in water corresponding to a sourness intensity value of 2, 3, 5, 10, and 15, respectively. A skilled artisan will recognize that depending on the sample/composition being tested, the number and range of standard solutions may be changed (e.g., using only the solutions corresponding to the 2 and 7 sourness intensity values). For each test composition, the panelists dispenses approximately 2-5 mL, for liquid compositions or solutions prepared with water, or 5-10 g, for solid compositions, of each composition into their own mouths, disperses the composition by moving their tongues/chewing, and records a sourness intensity value between 0 and 15 for each composition based on comparison to the aforementioned standard citric acid solutions. Between tasting compositions, the panelists are able to cleanse their palates with water. The panelists also can taste the standard 0.035%, 0.05%, 0.07%, 0.15%, and 0.2% citric acid solutions ad libitum between tasting test solutions to ensure recorded sourness intensity values are accurate against the scale of the standard citric acid solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Sourness Intensity Test.”

Bitterness of a composition can be tested by a panel of at least two panelists. The panelists can use a standard range of 0.0125% (wt), 0.01875% (wt), 0.025% (wt), 0.031% (wt), 0.07% (wt), and 0.12% (wt) caffeine solutions in water corresponding to a bitterness intensity value of 2, 3, 4, 5, 10, and 15, respectively. A skilled artisan will recognize that depending on the sample/composition being tested, the number and range of standard solutions may be changed (e.g., using only the solutions corresponding to the 2, 3, and 5 bitterness intensity values). For each test composition, the panelists dispenses approximately 2-5 mL, for liquid compositions or solutions prepared with water, or 5-10 g, for solid compositions, of each composition into their own mouths, disperses the composition by moving their tongues/chewing, and records a bitterness intensity value between 0 and 15 for each composition based on comparison to the aforementioned standard caffeine solutions. Between tasting compositions, the panelists are able to cleanse their palates with water. The panelists also can taste the standard 0.0125%, 0.01875%, 0.025%, 0.031%, 0.07%, and 0.12% caffeine solutions ad libitum between tasting test solutions to ensure recorded bitterness intensity values are accurate against the scale of the standard caffeine solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Bitterness Intensity Test.”

Sweetness of a composition can be tested by a panel of at least two panelists. The panelists can use a standard range of 2% (wt), 5% (wt), 8% (wt), 10% (wt), and 15% (wt) sucrose solutions corresponding to a sweetness intensity value of 2, 5, 8, 10, and 15, respectively. A skilled artisan will recognize that depending on the sample/composition being tested, the number and range of standard solutions may be changed (e.g., using only the solutions corresponding to the 2, 5, and 8 sweetness intensity values). For each test composition, the panelists dispenses approximately 2-5 mL, for liquid compositions or solutions prepared with water, or 5-10 g, for solid compositions, of each composition into their own mouths, disperses the composition by moving their tongues/chewing, and records a sweetness intensity value between 0 and 15 for each composition based on comparison to the aforementioned standard sucrose solutions. Between tasting compositions, the panelists are able to cleanse their palates with water. The panelists also can taste the standard 2%, 5%, 8%, 10%, and 15% sucrose solutions ad libitum between tasting test solutions to ensure recorded sweetness intensity values are accurate against the scale of the standard sucrose solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Sweetness Intensity Test.”

Umami of a composition can be tested by a panel of at least two panelists. The panelists can use a standard range of 0.75% (wt) and 0.125% (wt) monosodium glutamate (MSG) solutions corresponding to an umami intensity value of 4 and 6.5, respectively. A skilled artisan will recognize that depending on the sample/composition being tested, the number and range of standard solutions may be changed (e.g., adding additional umami solutions if the umami intensity is expected to be appreciably outside of the umami intensity value of 4-6.5). For each test composition, the panelists dispenses approximately 2-5 mL, for liquid compositions or solutions prepared with water, or 5-10 g, for solid compositions, of each composition into their own mouths, disperses the composition by moving their tongues/chewing, and records an umami intensity value between 0 and 15 for each composition based on comparison to the aforementioned standard MSG solutions. Between tasting compositions, the panelists are able to cleanse their palates with water. The panelists also can taste the standard 0.075% and 0.125% MSG solutions ad libitum between tasting test solutions to ensure recorded umami intensity values are accurate against the scale of the standard MSG solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Umami Intensity Test.”

A control sample is typically used as a reference point or for comparison purposes. For example, a control sample can be used to qualify the effectiveness of a sensory modifier. The control sample can be a composition such as a composition as described herein, but without the presence of the sensory modifier. Other than the sensory modifier, the control sample is otherwise the same, and it should contain the same component(s) and other ingredients at the same relative concentrations. Other standard samples are commonly used in sensory panels, for example standard samples used to evaluate intensity of sensory attributes as outlined above. In other aspects, the control sample may be a modified control sample which contains a different sensory modifier such as a competitor sensory modifier.

This disclosure is not limited to sensory testing by experienced or trained panelists. For example, it is possible to utilize untrained and inexperienced panelists. However, in the case of untrained and inexperienced panelists, a greater number of these panelists is usually necessary to provide reproducible results, which will typically focus on subjective attributes such as preference or overall liking. Similarly, untrained and inexperienced panelists may be asked to evaluate relative changes in a given sensory attribute between two samples. For example, if a particular sample is more or less salty, more or less sweet, more or less bitter, etc., than a reference sample.

An exemplified sensory assay and test criteria for further sensory attributes are described in the Examples provided in this disclosure.

In some aspects, the amount of sensory modifier effective to decrease bitterness can be the amount effective to reduce bitterness intensity by at least 0.5, 1, 1.5, 2, or at least 2.5 units relative to bitterness intensity in an equivalent composition lacking the sensory modifier. The bitterness intensity score is determined by at least three panelists trained in tasting bitter compositions using a roundtable methodology using a scale of 0 to 9, where a score of 0 indicates no bitterness and 9 indicates extreme bitterness intensity (i.e., 0=not detected, 1=trace, 2=faint, 3=slight, 4=mild, 5=moderate, 6=definite, 7=strong, 8=very strong, 9=extreme). In some aspects, the bitterness may be reduced by at least 2, at least 3, or at least 4 units. Similar evaluation processes may be used to score other sensory attributes of the composition described herein.

In some aspects, the amount of sensory modifier effective to decrease bitterness can be the amount effective to reduce bitterness intensity score by at least 0.5, 1, 1.5, 2, or at least 2.5 units relative to bitterness intensity in an equivalent composition lacking the sensory modifier. The bitterness intensity score may be determined as the average bitterness intensity score from at least seven panelists, trained in sensory evaluation, upon randomized balanced sequential order evaluation of samples using a scale of 0 to 15, where a score of 0 indicates no bitterness and 15 indicates extreme bitterness intensity. In some aspects, the bitterness may be reduced by at least 2, at least 3, at least 4 units, at least 5, at least 6, at least 7, or more units.

The compositions described herein can have various amounts of sensory modifier. The compositions described herein may include KCl and sensory modifier in a ratio between 12:1 and 45:1, between 15:1 and 40:1, or between 18:1 and 35:1. Sensory modifier can be present in the composition in any amount desired for the particular use. For example, the sensory modifier can be present in a dry potassium chloride composition at a total concentration from about 0.1% (wt) to about 20.0% (wt), from about 0.5% (wt) to about 15.0% (wt), or from about 1.0% (wt) to about 10.0% (wt). In some aspects, the sensory modifier is 1%-10% (wt), 2%-8% (wt), or 3%-6% (wt) of the dry composition. In some aspects, the sensory modifier can be present in a dry KCl composition at a total concentration of at least 0.5%, 1.0%, 1.5%, 2.0%, 3.0%, 4.0%, 5.0%, 6.0%, 7.0%, 8.0%, 9.0%, or at least 10% by weight of the composition. In some aspects, the sensory modifier can be present in a liquid KCl composition at a concentration from 0.001% (wt) to 1.0% (wt), 0.001% (wt) to 0.5% (wt), 0.005% (wt) to 0.1% (wt), 0.005% (wt) to 0.050% (wt), or 0.005% (wt) to 0.02% (wt). The liquid composition may contain at least 0.001%, 0.002%, 0.005%, 0.01%, 0.02%, or 0.05% by weight of the sensory modifier. The liquid bitterant composition may include the sensory modifier at a concentration up to 1.0% (wt), 0.5% (wt), 0.25% (wt), 0.2% (wt), 0.1% (wt), or 0.05% (wt).

The sensory modifier can be present in the composition at a total concentration such that when added to water or an aqueous solution, the resulting aqueous composition includes from 0.001% (wt) to 1.0% (wt), 0.001% (wt) to 0.5% (wt), 0.005% (wt) to 0.1% (wt), 0.005% (wt) to 0.050% (wt), or 0.005% (wt) to 0.02% (wt) of the sensory modifier. The composition may include the sensory modifier at a concentration such that an aqueous composition made therefor contains of at least 0.001%, 0.002%, 0.005%, 0.01%, 0.02%, or 0.05% by weight of the sensory modifier. The composition may include the sensory modifier at a concentration such that an aqueous composition prepared therefrom contains up to 1.0% (wt), 0.5% (wt), 0.25% (wt), 0.2% (wt), 0.1% (wt), or 0.05% (wt) of the sensory modifier.

The dry composition can comprise an amount of sensory modifier such that, when the dry composition is added to an aqueous solution, the sensory modifier is present in the aqueous solution in an amount desired for a particular use. For example, sensory modifier can be present in the aqueous solution at a total concentration from about 1 ppm to about 1000 ppm, or from about 1 ppm to about 2000 ppm. In some aspects, sensory modifier can be present in the aqueous solution at a total concentration from about 100 ppm to about 2000 ppm, about 200 ppm to about 2000 ppm, 300 ppm to about 2000 ppm, 400 ppm to about 2000 ppm, 500 ppm to about 2000 ppm, 600 ppm to about 2000 ppm, 700 ppm to about 2000 ppm, 800 ppm to about 2000 ppm, 900 ppm to about 2000 ppm, or 1000 ppm to about 2000 ppm. In some aspects, sensory modifier can be present in the aqueous solution at a total concentration of or greater than about 10, 100, 200, 300, 400, 500, 600, 700, 800, 900, 1000, 110, 1200, 1300, 1400, 1500, 1600, 1700, 1800, 1900, or 2000 ppm. In various aspects, the sensory modifier can be present in the aqueous solution at a total concentration from about 100 ppm to about 1000 ppm, about 200 ppm to about 1000 ppm, 300 ppm to about 1000 ppm, 400 ppm to about 1000 ppm, 500 ppm to about 1000 ppm, 600 ppm to about 1000 ppm, 700 ppm to about 1000 ppm, 800 ppm to about 1000 ppm, or 900 ppm to about 1000 ppm. In some aspects, sensory modifier can be present in the aqueous solution at a total concentration from about 100 ppm to about 800 ppm, about 200 ppm to about 800 ppm, 300 ppm to about 800 ppm, 400 ppm to about 800 ppm, 500 ppm to about 800 ppm, 600 ppm to about 800 ppm, or 700 ppm to about 800 ppm. In some aspects, sensory modifier can be present in the aqueous solution at a total concentration from about 400 ppm to about 800 ppm.

Likewise, the dry composition can comprise an amount of sensory modifier such that, when the dry composition is used in the preparation of a food product, the sensory modifier is present in the resulting food product in an amount desired for a particular use. For example, sensory modifier can be present in the food product at a total concentration from about 1 ppm to about 1000 ppm, or from about 1 ppm to about 2000 ppm. In some aspects, sensory modifier can be present in the food product at a total concentration from about 100 ppm to about 2000 ppm, about 200 ppm to about 2000 ppm, 300 ppm to about 2000 ppm, 400 ppm to about 2000 ppm, 500 ppm to about 2000 ppm, 600 ppm to about 2000 ppm, 700 ppm to about 2000 ppm, 800 ppm to about 2000 ppm, 900 ppm to about 2000 ppm, or 1000 ppm to about 2000 ppm. In some aspects, sensory modifier can be present in the food product at a total concentration of or greater than about 10, 100, 200, 300, 400, 500, 600, 700, 800, 900, 1000, 110, 1200, 1300, 1400, 1500, 1600, 1700, 1800, 1900, or 2000 ppm. In various aspects, the sensory modifier can be present in the food product at a total concentration from about 100 ppm to about 1000 ppm, about 200 ppm to about 1000 ppm, 300 ppm to about 1000 ppm, 400 ppm to about 1000 ppm, 500 ppm to about 1000 ppm, 600 ppm to about 1000 ppm, 700 ppm to about 1000 ppm, 800 ppm to about 1000 ppm, or 900 ppm to about 1000 ppm. In some aspects, sensory modifier can be present in the food product at a total concentration from about 100 ppm to about 800 ppm, about 200 ppm to about 800 ppm, 300 ppm to about 800 ppm, 400 ppm to about 800 ppm, 500 ppm to about 800 ppm, 600 ppm to about 800 ppm, or 700 ppm to about 800 ppm. In some aspects, sensory modifier can be present in the food product at a total concentration from about 400 ppm to about 800 ppm.

The amount of an individual sensory modifier species in the various compositions described herewith can each independently vary. For example, monocaffeoylquinic acid, dicaffeoylquinic acid, or both, can each individually be present in the composition at a concentration from about 1 ppm to about 1000 ppm. In some aspects, monocaffeoylquinic acid, dicaffeoylquinic acid, or both, can each individually be present in the composition at a concentration from about 100 ppm to about 1000 ppm, about 200 ppm to about 1000 ppm, 300 ppm to about 1000 ppm, 400 ppm to about 1000 ppm, 500 ppm to about 1000 ppm, 600 ppm to about 1000 ppm, 700 ppm to about 1000 ppm, 800 ppm to about 1000 ppm, 900 ppm to about 1000 ppm. In some aspects, monocaffeoylquinic acid, dicaffeoylquinic acid, or both, can each individually be present at a concentration of or greater than about 10, 50, 100, 200, 300, 400, 500, 600, 700, 800, 900, or 1000 ppm in the dairy substitute composition. In some aspects, monocaffeoylquinic acid, dicaffeoylquinic acid, or both, can each individually be present in the met substitute composition at a concentration from about 100 ppm to about 800 ppm, about 200 ppm to about 800 ppm, 300 ppm to about 800 ppm, 400 ppm to about 800 ppm, 500 ppm to about 800 ppm, 600 ppm to about 800 ppm, or 700 ppm to about 800 ppm. In some aspects, monocaffeoylquinic acid, dicaffeoylquinic acid, or both, can each individually be present in the dairy substitute composition at a concentration from about 400 ppm to about 800 ppm.

In some aspects, an effective amount of the sensory modifier is an amount effective to reduce bitterness, reduce metallic notes, and to improve temporal aspects of saltiness in a beverage or food product prepared from a potassium chloride composition described herein, when the potassium chloride is used to replace at least a portion of sodium chloride in the beverage or food product. For example, KCl may be used to replace at least a portion of NaCl in a beverage or food product to reduce the total sodium content of said food or beverage product. However, the substitution of KCl for NaCl may change the bitterness, metallic notes, and/or the saltiness flavor profile of the beverage or food product. Without being bound by any particular theory, embodiment, or mode of action, it is believed that additional sodium reduction in a beverage or a food product can be achieved by using the described sensory modifiers in addition to the KCl because more KCl can be used than would be possible without the sensory modifier. Addition of the sensory modifier reduces bitterness and metallic notes imparted by the KCl and improves the saltiness flavor profile of the resulting beverage or food product. Therefore, when KCl is used in combination with the sensory modifiers described herein, more KCl can be used (more sodium can be replaced) to impart further sodium reduction to a given beverage or food product. For example, the amount of sodium in a composition may be at least 10%, at least 15%, at least 20%, at least 25%, at least 30%, at least 40%, or at least 50% less than the amount of sodium required in a composition having the same saltiness intensity value but lacking the sensory modifier, wherein the saltiness intensity value is measured by the Standardized Saltiness Intensity Test. The amount of sensory modified used in a beverage or food product may be an amount such that when potassium chloride is used to replace at least 10%, at least 15%, at least 20%, at least 25%, at least 30%, at least 40%, or at least 50% of the sodium in the composition, the composition retains a saltiness intensity value, bitterness intensity value, and/or metallic notes intensity value within 0.5, 1, 1.5, or 2 units of the original composition lacking the potassium chloride and sensory modifier. The saltiness intensity value, bitterness intensity value, and metallic notes intensity value may be measured using the methods described herein.

### Botanical Source of Sensory Modifier

In various aspects, the sensory modifier can be isolated from botanical sources. Various botanical sources comprise sensory modifiers and sensory modifiers can be isolated from these botanical sources. Some examples of botanical sources from which sensory modifiers can be isolated include Eucommia ulmoides, honeysuckle, Nicotiana benthamiana, artichoke, globe artichoke, cardoon, Stevia rebaudiana, monkfruit, coffee, coffee beans, green coffee beans, tea, white tea, yellow tea, green tea, oolong tea, black tea, red tea, post-fermented tea, bamboo, heather, sunflower, blueberries, cranberries, bilberries, grouseberries, whortleberry, lingonberry, cow berry, huckleberry, grapes, chicory, eastern purple coneflower, echinacea, Eastern pellitory-of-the-wall, Upright pellitory, Lichwort, Greater celandine, Tetterwort, Nipplewort, Swallowwort, Bloodroot, Common nettle, Stinging nettle, Potato, Potato leaves, Eggplant, Aubergine, Tomato, Cherry tomato, Bitter apple, Thorn apple, Sweet potato, apple, Peach, Nectarine, Cherry, Sour cherry, Wild cherry, Apricot, Almond, Plum, Prune, Holly, Yerba mate, Mate, Guayusa, Yaupon Holly, Kuding, Guarana, Cocoa, Cocoa bean, Cacao, Cacao bean, Kola nut, Kola tree, Cola nut, Cola tree, Ostrich fern, Oriental ostrich fern, Fiddlehead fern, Shuttlecock fern, Oriental ostrich fern, Asian royal fern, Royal fern, Bracken, Brake, Common bracken, Eagle fern, Eastern brakenfern, Clove, Cinnamon, Indian bay leaf, Nutmeg, Bay laurel, Bay leaf, Basil, Great basil, Saint-Joseph's-wort, Thyme, Sage, Garden sage, Common sage, Culinary sage, Rosemary, Oregano, Wild marjoram, Marjoram, Sweet marjoram, Knotted marjoram, Pot marjoram, Dill, Anise, Star anise, Fennel, Florence fennel, Tarragon, Estragon, Mugwort, Licorice, Liquorice, Soy, Soybean, Soyabean, Soya vean, Wheat, Common wheat, Rice, Canola, Broccoli, Cauliflower, Cabbage, Bok choy, Kale, Collard greens, Brussels sprouts, Kohlrabi, Winter's bark, Elderflower, Assa-Peixe, Greater burdock, Valerian, and Chamomile.

Some botanical sources may produce sensory modifiers that are enriched for one or more of caffeic acid, monocaffeoylquinic acids, and dicaffeoylquinic acids. For example, sensory modifiers isolated from yerba mate plant (Ilex paraguariensis) are enriched for monocaffeoylquinic and dicaffeoylquinic acids. In other aspects, sensory modifiers isolated from yerba mate plant that are enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more of a combination of one or more of 1,3-dicaffeoylquinic acid, 1,4-dicaffeoylquinic acid, 1,5-dicaffeoylquinic acid, 3,4-dicaffeoylquinic, 3,5-dicaffeoylquinic acid, and 4,5-dicaffeoylquinic acid, and salts thereof. For example, sensory modifiers isolated from other botanical sources can be enriched for dicaffeoylquinic acids. In other aspects, sensory modifiers isolated from other botanical sources that are enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more of a combination of one or more of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid, and salts thereof.

Sensory modifier may be isolated in a variety of ways. Some suitable processes are disclosed in more detail in U.S. application Ser. No. 16/373,206, filed Apr. 4, 2019 and entitled “Steviol Glycoside Solubility Enhancers,” which was published on Jul. 25, 2019 as US Patent Application Publication No. 2019/0223481; International Application No. PCT/US2018/054691, filed Oct. 5, 2018 and entitled “Steviol Glycoside Solubility Enhancers;” U.S. Provisional Application No. 62/569,279, filed Oct. 6, 2017, and entitled “Steviol Glycoside Solubility Enhancers;” U.S. application Ser. No. 16/374,894, filed Apr. 4, 2019 and entitled “Methods for Making Yerba Mate Composition,” which was published on Aug. 1, 2019 as US Patent Application Publication No. 2019/0231834; International Application No. PCT/US2018/054688, filed Oct. 5, 2018 and entitled “Methods for Making Yerba Mate Composition;” U.S. Provisional Application Ser. No. 62/676,722, filed May 25, 2018, and entitled “Methods for Making Yerba Mate Extract Composition;” and International Application No. PCT/US2020/026885 filed Apr. 6, 2020, entitled “Stevia Processing,” and published as WO 2020/210161 on Oct. 15, 2020, each of which is incorporated herein by reference. For example, sensory modifier may be isolated from a botanical source that comprises one or more of monocaffeoylquinic acid, dicaffeoylquinic acid, and salts thereof. For example, yerba mate biomass and stevia biomass can be used to prepare sensory modifier. In one exemplary process, sensory modifier is prepared from commercially obtained comminuted yerba mate biomass. Briefly, yerba mate biomass is suspended in 50% (v/v) ethanol/water, shaken for at least 1 hour, and the resulting mixture filtered to obtain an initial extract. The initial extract is diluted to 35% (v/v) ethanol with water and refiltered. Refiltered permeate is then applied to a column of AMBERLITE® FPA 53 resin that has been equilibrated in 35% (v/v) ethanol/water and the column permeate is discarded. The column is washed with 35% (v/v) ethanol/water and the column permeate is discarded. The column is then eluted with 10% (w/v) FCC grade sodium chloride in 50% (v/v) ethanol/water and the eluent retained. Nitrogen gas is blown at room temperature over a surface of the eluent to remove ethanol and reduce the eluent to ⅓ of its original volume. The reduced volume eluent is then filtered through a 0.2 μm polyethersulfone filter and then decolored by passing through a 3 kDa molecular weight cutoff membrane. The decolored permeate is retained and desalted by passing through a nanofiltration membrane. The desalted permeate is then freeze-dried to obtain the sensory modifier. This process is also suitable to obtain sensory modifier from stevia biomass and can be adapted to obtain sensory modifier from other botanical sources for example those described above.

In some aspects, the sensory modifier can be a blend of sensory modifier isolated from more than one botanical source.

Some compounds can adversely impact flavor or aroma of a potassium chloride composition or an aqueous solution or food product prepared therefrom. Certain sensory modifiers, such as those prepared from plant extract do not include one or more of the compounds shown in Table 2, or any combination thereof, above the disclosed preferred content levels. All preferred content levels are stated as weight percent on a dry weight basis. Certain commercially desirable solid (dry) sensory modifiers do not include more than the preferred level of any of the compounds listed in Table 2. For those compounds listed that are acids, the compound may be present in acid form and/or in slat form.

TABLE 2

| Class of | Preferred Content | % wt of compounds in steviol glycoside |
|---|---|---|
| compounds | Level (% wt) | solubility enhancer solid (dry) compositions |
| Organic acids | <3%, preferably | malonate, malonic acid, oxalate, oxalic acid, |
| | <2%, <1%, or 0% | lactate, lactic acid, succinate, succinic acid, |
| | | malate, malic acid, citrate, citric acid |
| | <0.5%, preferably | tartrate, tartaric acid, pyruvate, pyruvic acid, |
| | <0.25% or 0% | fumarate, fumaric acid, ascorbic acid, sorbate, |
| | | sorbic acid, acetate, acetic acid |
| Inorganic acids | <1%, preferably | sulfate, sulfuric acid, phosphate, phosphoric |
| | <0.5% or 0% | acid, nitrate, nitric acid, nitrite, nitrous acid, |
| | | chloride, hydrochloric acid, ammonia, |
| | | ammonium |
| Flavanoids, | <5%, preferably | quercetin, kaempferol, myricetin, fisetin, |
| isoflavanoids, and | <4%, <3%, or <2%, | galangin, isorhamnetin, pachypodol, rhamnazin, |
| neoflavanoids | more preferably | pyranoflavonols, furanoflavonols, luteolin, |
| | <1%, <0.5%, or 0% | apigenin, tangeritin, taxifolin (or |
| | | dihydroquercetin), dihydrokaempferol, |
| | | hesperetin, naringenin, eriodictyol, |
| | | homoeriodictyol, genistein, daidzein, glycitein |
| Flavanoid | <5%, preferably | hesperidin, naringin, rutin, quercitrin, luteolin- |
| glycosides | <4%, <3%, or <2%, | glucoside, quercetin-xyloside |
| | more preferably | |
| | <1%, <0.5%, or 0% | |
| Anthocyanidins | <5%, preferably | cyanidin, delphinidin, malvidin, pelargonidin, |
| | <4%, <3%, or <2%, | peonidin, petunidin |
| | more preferably | |
| | <1%, <0.5%, or 0% | |
| Tannins | <1%, preferably | tannic acid |
| | <0.5%, <0.25%, or | |
| | 0% | |
| Amino acids + | <0.1%, preferably | alanine, arginine, asparagine, aspartic acid, |
| total protein | <0.05%, or 0% | cysteine, glutamine, glutamic acid, glycine, |
| | | histidine, isoleucine, leucine, lysine, methionine, |
| | | phenylalanine, proline, serine, threonine, |
| | | tryptophan, tyrosine, and valine |
| Total Fat | <1%, preferably | monoglycerides, diglycerides, triglycerides |
| | <0.5%, <0.25%, or | |
| | 0% | |
| Monosaccharides, | <1% | glucose, fructose, sucrose, galactose, ribose, |
| disaccharides, and | | trehalose, trehalulose, lactose, maltose, |
| polysaccharides | | isomaltose, isomaltulose, mannose, tagatose, |
| | | arabinose, rhamnose, xylose, dextrose, erythrose, |
| | | threose, maltotriose, panose |
| Sugar alcohols | <1% | glycerol, sorbitol, mannitol, xylitol, maltitol, |
| | | lactitol, erythritol, isomalt, inositol |
| Dietary fiber | <0.1%, preferably | acacia (arabic) gum, agar-agar, algin-alginate, |
| | <0.05% or 0% | arabynoxylan, beta-glucan, beta mannan, |
| | | carageenan gum, carob or locust bean gum, |
| | | fenugreek gum, galactomannans, gellan gum, |
| | | glucomannan or konjac gum, guar gum, |
| | | hemicellulose, inulin, karaya gum, pectin, |
| | | polydextrose, psyllium husk mucilage, resistant |
| | | starches, tara gum, tragacanth gum, xanthan |
| | | gum, cellulose, chitin, and chitosan |
| Steviol glycoside | <55% | stevioside; steviolbioside; rubusoside; 13- and |
| compounds | | 19-SMG; dulcosides A, B, C, D; and |
| | | rebaudiosides A, B, C, D, E, F, I, M, N, O, T |
| Saponins | <2%, preferably | glycosylated ursolic acid and glycosylated |
| | <1%, <0.5%, | oleanolic acid |
| | <0.25%, or 0% | |
| Terpenes other | <2%, preferably | eugenol, geraniol, geranial, alpha-ionone, beta- |
| than saponins and | <1%, <0.5%, | ionone, epoxy-ionone, limonene, linalool, |
| steviol glycoside | <0.25%, or 0% | linalool oxide, nerol, damascenone |
| compounds | | |
| Lipid oxidation | <2%, preferably | Decanone, decenal, nonenal, octenal, heptenal, |
| products | <1%, <0.5%, | hexenal, pentenal, pentenol, pentenone, |
| | <0.25%, or 0% | hexenone, hydroxynonenal, malondialdehyde |
| Polycyclic | <0.1%, preferably | Acenaphthene, Acenaphthylene, Anthracene, |
| Aromatic | <0.05% or 0% | Benzo(a)anthracene, Benzo(a)pyrene, |
| Hydrocarbons | | Benzo(b)fluoranthene, Benzo(ghi)perylene, |
| | | Benzo(k)fluoranthene, Chrysene, |
| | | Dibenzo(a, h)anthracene, Fluoranthene, Fluorene, |
| | | Indeno(1,2,3-cd)pyrene, Naphthalene, |
| | | Phenanthrene, Pyrene |
| Other compounds | <0.1%, preferably | chlorophyll, furans, furan-containing chemicals, |
| | <0.05% or 0% | theobromine, theophylline, and trigonelline |
| | <1%, preferably | saponins |
| | <0.5%, <0.25%, or | |
| | 0% | |

In some aspects, the sensory modifier comprises less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll.

The present invention can be better understood by reference to the following examples which are offered by way of illustration. The present invention is not limited to the examples given herein.

### EXAMPLES

### Materials and Methods

The tested sensory modifier was a mixture of monocaffeoylquinic and dicaffeoylquinic acids and salts prepared from yerba mate and having a ratio of salt fraction to acid fraction of 65:35. Table 3 lists the contents and source of various components.

Solutions were prepared which contained sodium chloride (NaCl) or potassium chloride (KCl) alone, for use as a control sample, or NaCl or KCl together with a sensory modifier. Solutions with NaCl, KCl, and a sensory modified were also prepared. Solutions were prepared by dissolving the NaCl, KCl, and/or sensory modifier into reverse osmosis water at the indicated concentrations and/or ratios. Some compositions included a sweetener or other ingredients as indicated in the Examples below.

TABLE 3

| Component | Ingredients | Source |
|---|---|---|
| Sensory Modifier | Mixture containing mono- and | Cargill, Inc. |
| | dicaffeoylquinic acids and salts, | (Wayzata, MN) |
| | prepared from Yerba mate | |
| | 65:35 ratio of salt:acid from | |

Assays were carried out to characterize the sensory attributes of the NaCl and/or KCl aqueous solutions with various amounts of sensory modifier. Sensory attributes of the solutions were tested by a panel of individuals that are experienced in sensory testing. The experienced panelists assessed flavor attributes such as saltiness, temporal aspects of saltiness, metallic taste, bitterness, and mouth drying. In some Examples, a roundtable methodology was used to assess various flavor attributes. To test each solution, the experienced panelists dispensed approximately 2 mL of each solution into their own mouths by transfer pipet, dispersed the solution by moving their tongues, and recorded a value or comments for the attribute(s) being tested. Between tasting solutions, the panelists were able to cleanse their palates with water.

Assays were carried out to assign a saltiness intensity value to potassium chloride compositions in aqueous solution with various amounts of sensory modifier. Saltiness intensity values were measured by a panel of individuals that are experienced in sensory testing. The experienced panelists used a standard range of 0.18%, 0.35%, 0.5%, and 0.567% sodium chloride solutions corresponding to saltiness intensity values of 2, 5, 8.5, and 10, respectively as a scale against which to measure saltiness intensity values. To test each solution, the experienced panelists dispensed 3-4 mL of each solution into their own mouths, dispersed the solution by moving their tongues, and individually recorded a value for saltiness intensity. Between tasting solutions, the panelists were able to cleanse their palates with water.

Assays were carried out to characterize the sensory attributes, e.g., bitterness, of potassium chloride solutions and samples with various amounts of sensory modifier. Sensory attributes of the compositions were tested by a panel of individuals that are experienced in sensory testing. The experienced panelists assessed sensory attributes such as, but not limited to, bitterness, metallic notes, mouth drying, and saltiness. Sensory attributes were scored on a scale of 0-9 with 0 indicating no sensory attribute intensity and 9 indicating an extreme sensory attribute intensity (i.e., 0=none, 1=trace, 2=faint, 3=slight, 4=mild, 5=moderate, 6=definite, 7=strong, 8=very strong, 9=extreme). In some Examples, a roundtable methodology was used to assess various flavor attributes. To test each composition, the experienced panelists dispensed approximately 2-4 fl oz of each sample or solution into their own mouths, dispersed the solution by moving their tongues, and individually recorded a sensory attribute scale value. Between tasting solutions, the panelists were able to cleanse their palates with water.

Assays in which a particular methodology or panel were used are noted in the individual examples below.

### Example 1—KCl Solutions

Assays were carried out to characterize sensory attributes of KCl aqueous solutions. Saltiness intensity of the KCl solutions was evaluated by a panel of individuals experienced in sensory testing using the assay method and standardized NaCl solutions described above. Bitterness was evaluated at the same time by the same panelists using the scale of 0-9 described above. The aqueous solutions used in this assay were prepared by dissolving the KCl in reverse osmosis water. The KCl composition formulations and saltiness intensity values are reported in Table 4.

TABLE 4

| | | | Saltiness | |
|---|---|---|---|---|
| Water | KCl | | Intensity | |
| (wt %) | (wt %) | Bitterness | Value | Comments |
| 99.82% | 0.18% | 3.5 | Noticeably | Intermediate mouthfeel, slight |
| | | | less than 2 | starchy note, upfront bitter- |
| | | | | ness that builds to a slight |
| | | | | to mild intensity |
| 99.65% | 0.35% | 5 | 3 | Fast bitterness onset quickly |
| | | | | reaching peak intensity, mild |
| | | | | to moderate intensity mouth |
| | | | | drying aftertaste |

### Example 2—KCl Solutions

Assays were carried out to characterize sensory attributes of KCl aqueous solutions with varying amounts of sensory modifier. Saltiness intensity of the KCl solutions was evaluated by a panel of individuals experienced in sensory testing using the assay method and standardized NaCl solutions described above. Bitterness was evaluated at the same time by the same panelists using the scale of 0-9 described above. The aqueous solutions used in this assay were prepared by dissolving the KCl and the sensory modifier in reverse osmosis water. The KCl composition formulations and saltiness intensity values are reported in Table 5.

TABLE 5

| | | Sensory | | Saltiness | |
|---|---|---|---|---|---|
| Water | KCl | Modifier | | Intensity | |
| (wt %) | (wt %) | (wt %) | Bitterness | Value | Comments |
| 99.64% | 0.35% | 0.01% | 3.5 | Slightly | Slight delay in bitterness |
| | | | | greater | onset and reduction in bitter- |
| | | | | than 2 | ness intensity relative to 0.35% |
| | | | | | KCl alone, slightly later salti- |
| | | | | | ness onset compared to NaCl alone, |
| | | | | | more consistent saltiness |
| | | | | | throughout |
| 99.635% | 0.35% | 0.015% | 3 | Slightly | Slight delay in bitterness onset |
| | | | | greater | and further reduction of bitter- |
| | | | | than 2 | ness intensity relative to 0.35% |
| | | | | | KCl alone, slightly later saltiness |
| | | | | | onset compared to NaCl alone |

### Example 3—KCl and NaCl Solutions

Assays were carried out to characterize sensory attributes of KCl+NaCl aqueous solutions with and without sensory modifier. Saltiness intensity of the KCl+NaCl solutions was evaluated by a panel of individuals experienced in sensory testing using the assay method and standardized NaCl solutions described above. Bitterness was evaluated at the same time by the same panelists using the scale of 0-9 described above. The aqueous solutions used in this assay were prepared by dissolving the KCl, NaCl, and where applicable the sensory modifier in reverse osmosis water. The KCl/NaCl composition formulations and saltiness intensity values are reported in Table 6.

TABLE 6

| | 50/50 | | | | |
|---|---|---|---|---|---|
| | KCl/NaCl | Sensory | | Saltiness | |
| Water | salt substitute | Modifier | | Intensity | |
| (wt %) | (wt %) | (wt %) | Bitterness | Value | Comments |
| 99.82% | 0.18% | — | 3 | Noticeably | Slight lag in saltiness onset |
| | | | | less than 2 | compared to NaCl references, |
| | | | | | later bitterness onset which |
| | | | | | builds in intensity, slight |
| | | | | | intensity of metallic and mouth |
| | | | | | drying aftertastes |
| 99.81% | 0.18% | 0.01% | 1.5 | 2 | Slight lag in saltiness onset |
| | | | | | compared to NaCl references |
| | | | | | extended time at peak saltiness, |
| | | | | | reduction in intensity of |
| | | | | | metallic and mouth drying |
| | | | | | aftertastes (faint) |
| 99.65% | 0.35% | — | 4 | Noticeably | Very quick bitterness onset, |
| | | | | less than 5 | milk intensity of mouth drying |
| | | | | | aftertaste |
| 99.64% | 0.35% | 0.01% | 2.5 | Less than | Quick saltiness onset with |
| | | | | 5 | delayed bitterness onset, |
| | | | | | extended time at peak saltiness, |
| | | | | | slight intensity of metallic and |
| | | | | | mouth drying aftertastes |

### Example 4—KCl and NaCl Solutions

Assays were carried out to characterize sensory attributes of KCl+NaCl aqueous solutions with and without sensory modifier. Saltiness intensity of the KCl+NaCl solutions was evaluated by a panel of individuals experienced in sensory testing using the assay method and standardized NaCl solutions described above. Bitterness was evaluated at the same time by the same panelists using the scale of 0-9 described above. The aqueous solutions used in this assay were prepared by dissolving the KCl/NaCl in reverse osmosis water. The KCl/NaCl composition formulations and saltiness intensity values are reported in Table 7.

TABLE 7

| | | 50/50 | | | | |
|---|---|---|---|---|---|---|
| | | KCl/NaCl | | | | |
| | | salt | Sensory | | Saltiness | |
| | Water | substitute | Modifier | | Intensity | |
| Sample | (wt %) | (wt %) | (wt %) | Bitterness | Value | Comments |
| 4.1 | 99.65% | 0.35% | — | 4 | Noticeably | Quick saltiness and |
| | | | | | less than 5 | bitterness onset, |
| | | | | | | building bitterness |
| | | | | | | intensity |
| 4.2 | 99.64% | 0.35% | 0.01% | 2.5 | Less than | Quick onset of saltiness, |
| | | | | | 5 | delayed bitterness onset, |
| | | | | | | extended time at peak |
| | | | | | | saltiness, more rounded |
| | | | | | | saltiness profile, slight |
| | | | | | | intensity of metallic and |
| | | | | | | mouth drying aftertastes |
| 4.3 | 99.59% | 0.40% | 0.01% | | Less than | Quicker saltiness onset |
| | | | | | 5 | compared to sample 4.2 |
| 4.4 | 99.54% | 0.45% | 0.01% | 3 | Subtly less | Slight intensity of |
| | | | | | than 5 | metallic aftertaste |
| 4.5 | 99.535% | 0.45% | 0.015% | 1 | 5 | Similar saltiness |
| | | | | | | temporal profile and |
| | | | | | | intensity as 0.35% NaCl |
| | | | | | | (Salty 5 reference), trace |
| | | | | | | bitter aftertaste, faint |
| | | | | | | mouth drying aftertaste |

For assays carried out in this Example, samples 4.1 and 4.2 were compared directly. The addition of the sensory modifier in sample 4.2 improved the dynamics of the saltiness and extended time at max saltiness which resulted in a more sustained saltiness and rounded salty profile. The addition of the sensory modifier also reduced the bitterness and metallic aftertastes associated with the KCl.

Samples 4.2, 4.3, and 4.4. were also compared directly. Overall, the saltiness intensity of the 4.4 sample (0.45% KCl/NaCl+100 ppm sensory modifier) was very close to the saltiness intensity and profile of a 0.35% NaCl solution. This represents a total sodium reduction of 35% when sample 4.4 is used instead of the equivalent 0.35% NaCl solution (0.1125% Na⁺ in sample 4.4 vs. 0.175% Na⁺ in 0.35% NaCl sample).

Finally, samples 4.4 and 4.5 were compared directly. The addition of 150 ppm of the sensory modifier further improved the sensory attributes of the salt substitute solution. While the saltiness profile was similar to the 4.4 and 0.35% NaCl samples, the 4.5 sample had a marked reduction in bitterness and metallic/mouth drying aftertastes as well as a saltiness profile (timing, dynamics, and intensity) that was similar to the 0.35% NaCl solution (Salty 5 reference).

### Example 5—Marinara Sauce

Assays were carried out to characterize sensory attributes of marinara sauces containing KCl and the sensory modifier described herein. Saltiness intensity of the marinara sauces was evaluated by a panel of individuals experienced in sensory testing using the assay method and standardized NaCl solutions described above. The marinara sauces used in these assays were prepared by first mixing the water and starch in a blender and heating to 195° F. (90.6° C.). After the water and starch slurry is held in the blender at 195° F. (90.6° C.) for 5 minutes, the remining ingredients are added to the blender, and the mixture is heated while being mixed to 165° F. (73.9° C.). The mixture is cooled and stored for 1 week. The marinara sauce formulations are reported in Table 8.

TABLE 8

| | | | 25% Reduced Sodium |
|---|---|---|---|
| Ingredients | | 25% Reduced | with 150 ppm Sensory |
| (wt %) | Control | Sodium | modifier |
| Water | 29.82% | 29.83% | 29.81% |
| Tomato Paste | 8.00% | 8.00% | 8.00% |
| Tomato Sauce | 28.12% | 28.12% | 28.12% |
| Crushed Tomatoes | 28.12% | 28.12% | 28.12% |
| Modified Corn Starch | 2.00% | 2.00% | 2.00% |
| Sugar | 2.50% | 2.50% | 2.50% |
| Seasoning (Italian | 0.45% | 0.45% | 0.45% |
| seasoning, onion | | | |
| powder, garlic | | | |
| powder) | | | |
| Sodium Chloride | 1.00% | 0.57% | 0.57% |
| (NaCl) | | | |
| Potassium Chloride | — | 0.42% | 0.42% |
| (KCl) | | | |
| Sensory modifier | — | — | 0.015% |

All three samples were assayed the same day as they were prepared and one week later. At day 1, when compared to control the 25% reduced sodium sample was peaky with an initial acidic taste followed by a bitter aftertaste. In contrast, the reduced sodium sample with the sensory modifier was more balanced and was similar to the full sodium control. At 1 week, the sensory attributes were similar to the assays on day 1. Compared to the reduced sodium sample, the sample with the sensory modifier eliminated the acidity and had a more balanced and consistent flavor. While the overall saltiness intensity was similar to the reduced sodium, the overall flavor was improved, palatability was improved, and bitterness was decreased.

### Example 6—Popcorn

Assays were carried out to characterize sensory attributes of popcorn seasoned with KCl, NaCl, and various amounts the sensory modifier described herein. Saltiness intensity of the popcorn was evaluated by a panel of 5 individuals experienced in sensory testing using the assay method described above. In addition to the evaluation of saltiness intensity, bitterness, and metallic notes were evaluated on a scale of 0-9 (i.e., 0=none, 1=trace, 2=faint, 3=slight, 4=mild, 5=moderate, 6=definite, 7=strong, 8=very strong, 9=extreme), overall saltiness was also evaluated for onset of saltiness, timing to peak salty, and timing at peak saltiness.

The popcorn used in these assays was prepared by adding the NaCl, the mixture of NaCl and KCl, or a mixture of NaCl, KCl, and the sensory modifier to freshly prepared popcorn. For these assays, popcorn from freshly prepared in a standard popcorn machine using palm oil. The popcorn formulations are reported in Table 9 and sensory attributes are summarized in Table 10.

TABLE 9

| | | | 6.2 | | 6.3 | | 6.4 | |
|---|---|---|---|---|---|---|---|---|
| | | | Reduced Sodium | | Reduced | | Reduced | |
| | 6.1 | | (70/30 | | Sodium with | | Sodium with | |
| | Full Sodium | | combination of | | 300 ppm sensory | | 450 ppm sensory | |
| Sample | Control | | NaCl and KCl) | | modifier | | modifier | |
| Popcorn kernels | 80.0 | wt % | 79.85 | wt % | 79.82 | wt % | 79.80 | wt % |
| Palm oil | 18.50 | wt % | 18.50 | wt % | 18.50 | wt % | 18.50 | wt % |
| shortening | | | | | | | | |
| Sea salt powder | 1.50 | wt % | 1.05 | wt % | 1.05 | wt % | 1.05 | wt % |

| | | | | | | | |
|---|---|---|---|---|---|---|---|
| Potassium | — | 0.60 | wt % | 0.60 | wt % | 0.60 | wt % |
| Chloride (with | | | | | | | |
| <1% Tricalcium | | | | | | | |
| phosphate | | | | | | | |
| anticaking | | | | | | | |
| agent) | | | | | | | |

| | | | | | | |
|---|---|---|---|---|---|---|
| Sensory | — | — | 0.03 | wt % | 0.045 | wt % |
| Modifier | | | | | | |

TABLE 10

| Sample | 6.1 | 6.2 | 6.3 | 6.4 |
|---|---|---|---|---|
| Saltiness Onset | Immediate | Delayed | Immediate | Immediate |
| Timing to peak | Quick rise | Slow rise | Quick rise | Quick rise |
| salty | | | | |
| Saltiness | 4.5 | 4.5 | 4.5 | 3.5 |
| Intensity | | | | |
| Time at peak | Short | Short | Medium (longer | Short |
| saltiness | | | lasting than 6.1) | |
| Bitterness | 0 | 2 | 0 | 0 |
| Metallic | 0 | 4 | 1.5 | 1.5 |
| Comments | Popcorn flavor | Overall muted | Similar popcorn | Slight (3) mouth |
| | noticed after | popcorn flavor | aftertaste as 6.1 | drying that |
| | saltiness | profile due to | | builds with |
| | dissipates | delay of peak | | subsequent |
| | | saltiness | | tastes, overall |
| | | | | muted popcorn |
| | | | | flavor, overall |
| | | | | sample was |
| | | | | muted in flavor |
| | | | | compared to 6.1, |
| | | | | 6.2, and 6.3 |

These data demonstrate that the inclusion of the sensory modifier in samples 6.3 and 6.4 reduces the bitterness and metallic notes from the addition of KCl. Additionally, the reduced sodium samples with the sensory modifier (6.3 and 6.4) had a saltiness intensity and temporal saltiness characteristics (e.g., saltiness onset and timing to peak salty) that more closely mirrored the full sodium sample (6.1) rather than the reduced sodium sample (6.2). Addition of the sensory modifier with the KCl (i) reduces sodium and (ii) maintains the saltiness characteristics of the full sodium sample.

### Example 7—Gravy

Assays were carried out to characterize sensory attributes of chicken gravy incorporating KCl, NaCl, and/or various amounts the sensory modifier described herein. Saltiness intensity of the gravy was evaluated by a panel of 5 individuals experienced in sensory testing using the assay method described above. In addition to the evaluation of saltiness intensity, chicken flavor, herb flavor, umami, sweet brown, oxidized fat, and/or metallic aftertaste were evaluated on a scale of 0-9 (i.e., 0=none, 1=trace, 2=faint, 3=slight, 4=mild, 5=moderate, 6=definite, 7=strong, 8=very strong, 9=extreme).

The chicken gravy used in these assays was prepared by blending the dry ingredients, adding the chicken stock to the dry ingredients, and blending the mixture while heating. When the mixture reaches about 140° F., the mixer speed is reduced, and the butter is added and allowed to melt for 30 seconds after which the mixing speed is increased. The mixture is cooked at a temperature between 180-190° F. for 10 minutes. For these assays, the sensory modifier was added with the dry ingredients. The chicken gravy formulations are reported in Table 11 and sensory attributes are summarized in Table 12.

TABLE 11

| | | | | | 7.3 | | 7.4 | | 7.5 | |
|---|---|---|---|---|---|---|---|---|---|---|
| | 7.1 | | 7.2 | | 25% Reduced | | 25% Reduced | | 25% reduced | |
| | Full | | 25% Reduced | | Sodium with | | Sodium with | | sodium with | |
| | Sodium | | Sodium (1.3:1 KCl | | 100 ppm sensory | | 150 ppm sensory | | 200 ppm sensory | |
| Sample | Control | | replacement) | | modifier | | modifier | | modifier | |
| Chicken Stock, | 79.15 | wt % | 79.28 | wt % | 79.27 | wt % | 79.265 | wt % | 79.26 | wt % |
| Unsalted | | | | | | | | | | |
| Maltodextrin 10DE | 8.50 | wt % | 8.50 | wt % | 8.50 | wt % | 8.50 | wt % | 8.50 | wt % |
| Unsalted Butter | 6.50 | wt % | 6.50 | wt % | 6.50 | wt % | 6.50 | wt % | 6.50 | wt % |
| Modified Food Starch | 3.00 | wt % | 3.00 | wt % | 3.00 | wt % | 3.00 | wt % | 3.00 | wt % |
| Nonfat dairy milk | 0.75 | wt % | 0.75 | wt % | 0.75 | wt % | 0.75 | wt % | 0.75 | wt % |
| solids (low heat) | | | | | | | | | | |
| Yeast extract | 0.48 | wt % | 0.25 | wt % | 0.25 | wt % | 0.25 | wt % | 0.25 | wt % |
| Seasonings (sage, | 0.27 | wt % | 0.270 | wt % | 0.270 | wt % | 0.270 | wt % | 0.270 | wt % |
| thyme, onion | | | | | | | | | | |
| powder, white | | | | | | | | | | |
| pepper, rosemary) | | | | | | | | | | |
| Caramel Color | 0.10 | wt % | 0.10 | wt % | 0.10 | wt % | 0.10 | wt % | 0.10 | wt % |
| Xanthan Gum | 0.05 | wt % | 0.05 | wt % | 0.05 | wt % | 0.05 | wt % | 0.05 | wt % |
| Beta Carotene | 0.02 | wt % | 0.02 | wt % | 0.02 | wt % | 0.02 | wt % | 0.02 | wt % |
| NaCl | 1.18 | wt % | 0.87 | wt % | 0.87 | wt % | 0.87 | wt % | 0.87 | wt % |

| | | | | | | | | | |
|---|---|---|---|---|---|---|---|---|---|
| KCl | 0 | 0.41 | wt % | 0.41 | wt % | 0.41 | wt % | 0.41 | wt % |

| | | | | | | | | |
|---|---|---|---|---|---|---|---|---|
| Sensory Modifier | 0 | 0 | 0.01 | wt % | 0.015 | wt % | 0.02 | wt % |

TABLE 12

| Sample | 7.1 | 7.2 | 7.3 | 7.4 | 7.5 |
|---|---|---|---|---|---|
| Saltiness | 5.5 | 4 | 4.5 | 5 | 5 |
| Chicken | 5 | 4 | 4.5 | 5 | 4.5 |
| Flavor | (brown/roasted) | (chicken skin) | (brown/roasted similar | (brown/roasted) | (brown/roasted, but |
| | | | to sample 7.1) | | less sustained |
| | | | | | than sample 7.4) |
| Herb | 4 | 2 | 3 | 4 | 3 |
| Flavor | | | (increase in | (further increase in | |
| | | | rosemary flavor | rosemary flavor | |
| | | | compared to 7.1 | compared to 7.3) | |
| | | | and 7.2) | | |
| Other | Umami - 3 | Sweet brown - 3 | | Umami - 2 | |
| Flavor | | Oxidized fat - 3 | Oxidized fat - 2 | No oxidized fat notes | |
| Attributes | | Metallic | No metallic | | |
| | | aftertaste - 2 | aftertaste | | |
| Comments | Quick upfront | Delay in saltiness | Quicker saltiness | Quick upfront | Shorter duration |
| | saltiness | onset compared to | onset than sample | saltiness similar | of time at peak |
| | | sample 7.1 | 7.2. More sustained, | to sample 7.1. | saltiness than |
| | | | long lasting | Sustained, long | samples 7.1, 7.3, |
| | | | saltiness than 7.2 | lasting saltiness | and 7.4 |

These data demonstrate that the inclusion of the sensory modifier in samples 7.3, 7.4, and 7.5 restored the quick upfront saltiness of the control in the presence of KCl. Metallic aftertaste in the samples including sensory modifier was reduced or eliminated. Overall, addition of the sensory modifier with the KCl (i) reduces sodium in the chicken gravy and (ii) maintains the saltiness characteristics of the full sodium sample.

### Example 8—Marinara Sauce

Assays were carried out to characterize sensory attributes of marinara sauces containing KCl and the sensory modifier described herein. Marinara sauce samples evaluated in this example were prepared based on the formulations outlined in Table 13. First, the olive oil and onion were heated for 7-8 minutes with occasional stirring. Following heating, the remaining ingredients were added, stirred until well blended, and covered. The mixture was heated to 185° F. (85° C.) and held for 5 minutes. Following heating the mixture was removed from the cooking kettle and blast chilled.

All sensory attributes were scored on a scale of 1-15, with 1 indicated no intensity and 15 indicating strong intensity. Prior to the assays, 7 highly trained and experienced external taste panelists received training on standardized samples (sodium chloride solutions as salt standards, citric acid solutions as sour standards, caffeine solutions as bitter standards, MSG solutions as umami standards, etc.) using the 1-15 scale. The attribute identities used for each of the sensory attributes tested are outlined in Table 14. For the sensory attribute assays, the 7 panelists were given a break in between samples and provided with filtered water and saltine crackers only during breaks. Panelists were given approximately 2 oz of the marinara sauce samples for the assay. Each sensory attribute for each sample was scored individually by panelists and score were evaluated using standard statistical analysis. Sensory attribute assay results are provided in Tables 15 and 16.

Sensory attribute timing profiles (Table 16) were assayed using two spoonfuls of the sample. For the first spoonful, the time was started as the panelist sampled and the time was recorded when the panelist first took notice of saltiness. This time value, in seconds, was recorded as the Onset of Saltiness. For the second spoonful, the panelist sampled a tasterspoon full of the sample, and started the timer when peak saltiness was perceived. Panelists noted the time that peak saltiness began to decline (“Time at Max Salt”) and the time when the saltiness dissipates (“Salt Linger”). The same technique was used to measure Sweet Onset, Sweet Linger, Sour Onset, Sour Linger, and Bitter Linger.

TABLE 13

| | | 40% Reduced Sodium | |
|---|---|---|---|
| Ingredients | | with 260 ppm Sensory | 40% Reduced |
| (wt %) | Control | Modifier | Sodium |
| Olive oil | 1.200 | 1.200 | 1.200 |
| Diced onion | 5.000 | 5.000 | 5.000 |
| Diced tomato | 20.000 | 20.000 | 20.000 |
| (salt free) | | | |
| Crushed tomatoes | 20.000 | 20.000 | 20.000 |
| (salt free) | | | |
| Tomato puree | 49.350 | 49.194 | 49.220 |
| (salt free) | | | |
| Dried minced garlic | 0.550 | 0.550 | 0.550 |
| Sugar | 1.800 | 1.800 | 1.800 |
| Seasoning (black | 1.040 | 1.040 | 1.040 |
| pepper, garlic | | | |
| powder, onion | | | |
| powder, Italian | | | |
| seasoning, basil) | | | |
| Citric acid | 0.070 | 0.070 | 0.070 |
| Sodium Chloride | 0.990 | 0.590 | 0.590 |
| (NaCl) | | | |
| Potassium Chloride | — | 0.530 | 0.530 |
| (KCl) | | | |
| Sensory modifier | — | 0.026 | — |

TABLE 14

| Modality | Attribute | Definition |
|---|---|---|
| Taste | Sweet | Taste common to common sucrose. |
| | Salt | Taste common to table salt. |
| | Sour | Taste common to citric acid. |
| | Bitter | Taste common to caffeine and quinine. |
| | Umami | Taste common to monosodium glutamate (MSG). |
| Flavor | Tomato Flavor | Aromatics associated with cooked tomato products, |
| | | such as tomato sauce. |
| | Bulby Complex | Aromatics reminiscent of the fusion of cooked |
| | | garlic and onions. |
| | Garlic | Aromatics reminiscent of garlic powder in water. |
| | Onion | Aromatics reminiscent of onion powder in water. |
| | Herb Complex | Aromatics reminiscent of a blend of herbs, composed |
| | | of one or more of the following: oregano, basil, |
| | | dried celery seed, dilly, parsley, or others. |
| | Basil | Aromatics reminiscent of dried basil leaves in water. |
| | Oregano | Aromatics reminiscent of dried oregano in water. |
| | Black Pepper | Aromatics reminiscent of ground black pepper in water. |
| | Metallic | Aromatics reminiscent of iron or metallic compounds. |
| Mouthfeel | Astringent | The mouth drying sensation felt in different parts |
| | | of the mouth. |
| | Metallic Sensation | The mouthfeel resulting from iron or metallic |
| | | compounds, including a burning, fuzzy tongue sensation. |
| Time | Time to Onset | Definition: The time (in seconds) it takes from the |
| Attributes | | time you put the sample in your mouth, until you taste |
| | | the given attribute. |
| | | Technique: Take a spoonful of sample and swallow, do not |
| | | hold or spit. Once you taste the given attribute, hit |
| | | lap on your phone. That is your Time to Onset. |
| | Time at Max | Definition: The time (in seconds) the sample remains |
| | | at the highest intensity of the given attribute. |
| | | Technique: Take a spoonful of sample and swallow, do not |
| | | hold or spit. Once you hit peak intensity of the given |
| | | attribute, you will hit LAP, and then time how long it |
| | | remains at that highest intensity. Once it starts to drop |
| | | off then hit LAP again, that is your Time At Max. |
| | Linger | Definition: The time (in seconds) from when the sample |
| | | starts to drop from peak intensity until you no longer |
| | | discern that attribute. |
| | | Technique: Take a spoonful of sample and swallow, do not |
| | | hold or spit. Start you timer when the peak intensity of |
| | | given attribute starts to decline. Stop your timer when |
| | | you can no longer perceive the attribute in question. |
| | | This is your Linger. |

TABLE 15

| | | | Marinara Sauce | Marinara Sauce - |
|---|---|---|---|---|
| | | Marinara Sauce - | Reduced Sodium | Reduced Sodium |
| Attribute | | Full Sodium | (KCl) + ClearFlo | (KCl) |
| Taste | Sweet | 4.0 | 3.7 | 3.8 |
| | Salt | 8.1 ab | 8.3 a | 7.7 b |
| | Sour | 4.8 | 4.4 | 4.2 |
| | Bitter | 3.0 | 3.1 | 2.9 |
| | Umami | 4.1 | 4.4 | 4.3 |
| Flavor | Tomato Flavor | 7.4 ab | 7.6 a | 7.1 b |
| | Bulby Complex | 5.4 | 5.5 | 5.4 |
| | Garlic | 3.9 a | 3.2 b | 3.4 ab |
| | Onion | 3.3 b | 3.4 ab | 3.8 a |
| | Herb Complex | 4.9 ab | 4.7 b | 5.6 a |
| | Basil | 3.2 | 3.4 | 3.4 |
| | Oregano | 2.4 b | 2.9 ab | 3.5 a |
| | Black Pepper | 3.0 | 2.8 | 2.9 |
| | Metallic | 0.7 b | 3.2 a | 4.0 a |
| Aftertaste 15 s | Salt | 5.1 | 5.4 | 5.4 |
| | Sour | 3.3 | 3.0 | 3.4 |
| | Bitter | 2.9 | 2.9 | 2.9 |
| | Umami | 3.4 | 3.4 | 3.4 |
| | Tomato Flavor | 4.1 | 4.2 | 4.3 |
| | Bulby Complex | 3.2 | 3.3 | 3.4 |
| | Herb Complex | 2.6 b | 3.1 a | 3.1 ab |
| | Metallic Sensation | 0.9 c | 3.3 b | 5.1 a |
| | Astringent | 3.2 b | 3.8 a | 4.0 a |

Means with different letters (a, b) indicated significant difference at p ≤ 0.05
Intensity Scale - 0 (none) to 15 (extreme)

TABLE 16

| | | | Marinara Sauce - | Marinara Sauce - |
|---|---|---|---|---|
| | | Marinara Sauce - | Reduced Sodium | Reduced Sodium |
| Attributes | | Full Sodium | (KCl) + ClearFlo | (KCl) |
| Salt | Salt Onset | 1.27 b | 1.33 ab | 1.63 a |
| Time (in seconds) | Salt TAM | 7.3 | 7.2 | 7.2 |
| | Salt Linger | 9.4 | 9.9 | 10.7 |
| Sweet | Sweet Onset | 1.5 | 1.7 | 1.8 |
| Time (in seconds) | Sweet Linger | 6.7 | 7.3 | 8.8 |
| Sour | Sour Onset | 1.4 a | 1.1 b | 1.2 ab |
| Time (in seconds) | Sour Linger | 13.7 | 12.2 | 12.0 |
| Bitter | Bitter Linger | 13.5 | 10.3 | 12.2 |
| Time (in seconds) | | | | |

Means with different letters (a, b) indicated significant difference at p ≤ 0.05
Intensity Scale - 0 (none) to 15 (extreme)

When compared to the full sodium control, the reduced sodium sample containing the sensory modifier had a significantly higher intensity for metallic flavor, herb flavor at 15 s, metallic sensation at 15 s, and astringency at 15 s and was also charactered as having a significantly lower intensity for garlic flavor. When compared to the full sodium control, the reduced sodium sample (without the sensory modifier) has significantly higher intensities for onion flavor, oregano flavor, metallic flavor, metallic sensation at 15 s, and astringency at 15 s. While the reduced sodium sample has a significantly longer time to salt onset, the reduced sodium with sensory modifier sample had a salt onset closer to the control, but a quicker sour onset.

1. A composition comprising:
potassium chloride (KCl); and
a sensory modifier comprising
a dicaffeoylquicid acid or salt thereof; and
at least one compound selected from the group consisting of monocaffeoylquinic acids, monoferuloylquinic acids, diferuloylquinic acids, monocoumaroylquinic acids, dicoumaroylquinic acids, and salts thereof.

2. The composition of claim 1, additionally comprising sodium chloride (NaCl).

3. The composition of claim 1, wherein the ratio of KCl to sensory modifier is between 12:1 and 45:1.

4. The composition of claim 1, wherein the composition is a dry composition comprising 40% (wt) to 99% (wt) KCl.

5. The composition of claim 1, wherein the composition is a dry composition comprising 0.5% (wt) to 10% (wt) sensory modifier.

6. The composition of claim 1, wherein the composition is a dry composition comprising NaCl in an amount up to 75% (wt) of the composition.

7. The composition of claim 1, wherein the composition comprises KCl and NaCl in a ratio between 0.75:1 and 1:2.5.

8. (canceled)

9. (canceled)

10. The composition of claim 1, wherein the dicaffeoylquinic acid or dicaffeoylquinic salt comprises at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof.

11. The composition of claim 1, wherein the total of all dicaffeoylquinic acids and dicaffeoylquinic salts present in the sensory modifier comprises 25-75% (wt) of a total weight of the sensory modifier.

12. The composition of claim 1, wherein the sensory modifier comprises a monocaffeoylquinic component selected from the group consisting of chlorogenic acid, neochlorogenic acid, cryptochlorogenic acid, and salts thereof.

13. The composition of claim 1, wherein the sensory modifier comprises a monocaffeoylquinic component and a dicaffeoylquinic component that together comprise more than 50% (wt) of the sensory modifier.

14. The composition of claim 1, wherein, when in water to form a solution, bitterness of the solution is reduced by at least 0.5 units, at least 1 unit, at least 2 units, or at least 3 units relative to an aqueous solution prepared from an equivalent composition without the sensory modifier, wherein bitterness is measured by Standardized Bitterness Intensity Test.

15. The composition of claim 1, wherein the sensory modifier is present in the composition in an amount effective to reduce bitterness such that when the composition is dissolved in distilled water forming a solution with a KCl concentration of 3500 ppm, a bitterness score of the solution is reduced by at least 1 unit relative to a comparable solution without the sensory modifier, wherein bitterness score is determined by at least four panelists experienced in sensory testing using a roundtable methodology using a scale of 0 to 9 with a score of 0 indicating no bitterness and a score of 9 indicating extreme bitterness.

16. (canceled)

17. The composition of claim 1, wherein the composition additionally comprises an anticaking agent in an amount up to 1.0% (wt).

18. The composition of claim 17, wherein the anticaking agent is selected from the group consisting of magnesium carbonate, tricalcium phosphate, sodium ferrocyanide, and combinations thereof.

19. A beverage product comprising the composition of claim 1.

20. A dry powdered beverage comprising the composition of claim 1.

21. A food product comprising the composition of claim 1.

22. The food product of claim 21, wherein the food product comprises a seasoning, a sauce, a gravy, a dressing, a snack product, or a bakery product.

23. The food product of claim 21, wherein the food product comprises 0.001 (wt)% to 1.0 (wt)% of the sensory modifier.

24. The food product of claim 21, wherein the food product comprises NaCl, KCl, or combinations thereof in an amount up to 5% (wt).

25. The food product of claim 21, wherein the food product comprises a potato chip, a popcorn, a cracker, a pretzel, or combinations thereof.

26. A method for reducing bitterness in a potassium chloride (KCl) composition, the method comprising,
adding to a composition comprising KCl a sensory modifier comprising a dicaffeoylquicid acid or salt thereof and at least one compound selected from the group consisting of monocaffeoylquinic acids, monoferuloylquinic acids, diferuloylquinic acids, monocoumaroylquinic acids, dicoumaroylquinic acids, and salts thereof,
wherein, when added in water to form a solution, bitterness of the solution is reduced relative to bitterness of an aqueous solution prepared from an equivalent KCl composition lacking the sensory modifier.

27-53. (canceled)
